(19) United States
(12) Patent Application Publication
(10) Pub. No.: US 2014/0173287 A1
(43) Pub. Date: Jun. 19, 2014

(54) IDENTIFIER MANAGEMENT METHOD AND SYSTEM

(71) Applicant: Takeshi Mizunuma, Sagamihara (JP)

(72) Inventor: Takeshi Mizunuma, Sagamihara (JP)

(21) Appl. No.: 14/130,935

(22) PCT Filed: Jul. 9, 2012
(86) PCT No.: PCT/JP2012/067460

§ 371 Date: Jan. 6, 2014

(30) Foreign Application Priority Data
Jul. 11, 2011 (JP) 2011-153383

(51) Int. Cl. H04L 9/32

(52) U.S. Cl. CPC H04L 9/3247
USPC 713/176

(57) ABSTRACT

A unique identifier is assigned to each user, and a standard for evaluating the reliability of information dispatched on the Internet using the identifier to reveal the source of the information is achieved by: using the identifier as a search term, and acquiring a corresponding public key from information publicly available on the Internet; using the public key to verify a signature added to text information that includes the identifier; and confirming whether the source of the text information links back to the public key and the identifier. Thereby, an equivalence relation on the text information is established on the basis of the public key and identifier.

### TECHNICAL FIELD

The present invention relates to an identifier management method and system.

### BACKGROUND ART

At the present time, the number of Internet users in the world has increased beyond two billion and is expanding at an explosive pace. Most of these users are making use of community services in some way, for example, twitter, blogs, SNS, BBS and so forth. Any user can freely transmit information and exchange opinions through community services (Patent Document 1). In addition to this, real-time search has been realized and makes it possible to get valuable information about what's going on to bring a great change on everyday life.

On the other hand, since it can result in serious damages if personal information is leaked, users are usually using Internet services anonymously. While users may disclose personal information to service provision sides, such information as real names are usually not shared among users. On the other hand, since anonymous communication cannot provide reliability, Internet services on the basis of real names are working effectively in certain ranges.

### PRIOR ART LITERATURE

### Patent Document

[Patent Document 1]

Japanese Patent Published Application No. 2010-146452

### SUMMARY OF INVENTION

### Problems to be Solved by the Invention

While the use of anonymity seems to be required from the view point of protecting privacy, a number of messages on the network appears only mere aggregation of isolated opinions, such that “there are several opinions”. The information “who is saying” is important for evaluating the value of the opinion. Also, it is very useful for evaluating the reliability of that opinion what else the person saying that opinion has been saying. Furthermore, separated messages transmitted from anonymous users are accompanied by no responsibility, such that it is easy to transmit irresponsible messages.

Anonymous users of twitter or the like can be distinguished from one another by user names. On the other hand, celebrities are allowed to get verified accounts to avoid confusion due to impersonation or misleading user names. However, beside twitter, there are a number of sites where ordinary people can transmit information, for example, other community services, net auction sites, user reviews on Internet shopping, reader's columns on newspaper sites, Q&A sites, blogs, or any other SNS sites. There is no means for uniformly distinguishing and securely verifying an anonymous user throughout the Internet including these sites.

In general, for evaluating whether certain information is reliable, the source is an important reference. If the source is an editorial article of a leading newspaper, it would be evaluated as worth reading. On the other hand, if a reliable person has provided the information, many persons would consider to spare time to read it. Particularly, in a time of disaster such as earthquake, eruption or the like, harmful rumors and canards often incur social problems. In an emergency situation, if there is some material supporting the believability of available information, it is sometimes effective to minimize damages.

For example, if the source is the site of a newspaper publisher, a certain level of the believability can be expected. However, there are three points at which information transmitted by ordinary users has advantages as follows. One advantage is that the information contains details. As for electronic products, in many cases, only personal level information can provide specific information such as information about a trouble in connection with a certain model and a certain specific manipulation, information in a specific field and a specific area. Another advantage is the speed of transmission of information. The information about an affair being in progress may be most readily provided by ordinary users who happen to be there. Furthermore, in terms of the amount of information, a huge number of ordinary users have an advantage.

Information becomes valuable not only when it is got but also when its reliability is evaluated. However, the amount of information transmitted everyday is far out of the capacity of individuals. The cooperative specialization of users seems indispensable. It is however difficult to distinguish valuable true information items from among a huge amount of information including false and harmful items. It is therefore important how to distinguish unnecessary information and select useful information in order to make use of the power of collective wisdom.

On the other hand, when a person posts an opinion to the reader's column of a journal site, that person must spend a certain labor and time. If the information is valuable for other people, the information have a certain value. Nonetheless, if the person is a no-name, the posted information is a one-shot information referred by the users who browsed the site.

Even if an unknown person posts information, this person gains only smugness of posting the information. In other words, the posted information is isolated but can generally not enhance the reliability of that person. There is little worth spending labor and time on posting information, so that people are not encouraged to provide valuable information by spending much time.

On the other hand, a real name can be used when posting information. Some SNS' require real name posting. However, it is substantially risky to make public a real name, for example, for privacy abuse. A real name SNS is inevitably closed in an exclusive environment.

Furthermore, the reliability of a real name itself is somewhat suspicious. A real name can be verified by complicated procedure as an electronic certificate. It requires much cost and troublesome procedure so that it is difficult to gain user understanding. Furthermore, since real name SNS' are small part of Internet services, other various services are separated therefrom. Still further, there are many identical or very similar real names which are shared by unrelated persons, resulting in complicated problems due to misunderstanding and spoofing.

There is another problem that, even if posting a very unique and valuable message, some other person may plagiarize that message. Particularly, this substantially hinders people from transmitting original works such as essays, pictures and music.

On the other hand, a person can be identified with a PKI. Irrespective of the fundamental potential, however, the PKI is prevailing only in one direction at least at the individual level. Namely, a service provider obtains a public key certificate, generates an electronic signature, provides a service to ordinary users who can confirm the service provider before making use of the service.

Fundamentally, the possibilities of the Internet would be further expanded by making it possible to use personal electronic certificates and personal electronic signatures. Unfortunately, it seems exceptional that an individual uses an electronic certificate.

This is because the use of PKI is cumbersome. Currently, in the case where an individual needs an electronic certificate, a personal electronic certificate can be obtained in accordance with required steps. This takes not only cumbersome procedure and much time but also a substantial cost. The effective period may be managed.

In addition, an electronic certificate can identify a user as an individual so that the management thereof must be carefully treated as a private seal. In one sense, an electronic certificate can identify a user as an individual more directly than a private seal so that, when the private key is leaked, its abuse is more likely. Furthermore, when an ordinary user acts on the Internet, it is always risky with respect to privacy leakage.

Accordingly, it is an object of the present invention to provide an environment where an individual can casually use electronic signatures for identification.

It is another object of the present invention to provide an environment where an individual can casually use electronic signatures even on an anonymous basis.

It is a further object of the present invention to assign a unique identifier to each user, and provide criteria for evaluating the reliability of information transmitted in the identifier by making clear the informational source.

### Means to Solve the Problems

In order to accomplish the object as described above, the identifier management method of the present invention comprises: acquiring a public key associated with an identifier from information disclosed in the Internet by the use of the identifier as a search term; verifying a signature attached to text information including the identifier; determining whether or not the origin of the text information is identified by the public key and the identifier; and thereby establishing an equivalence relation on the text information by the use of the public key and the identifier.

### Effects of the Invention

In accordance with the identifier management method of the present invention, any user transmitting information in the Internet can accumulate reliability in association with the identifier of the user. Also, since the real life can be separated by using the identifier on an anonymous basis, it is possible to avoid privacy risks.

Furthermore, in accordance with the identifier management method of the present invention, the transmission of valuable information directly benefits the transmitting user, and therefore each user actively transmit valuable information to make the Internet more profitable resulting in the public interest.

Still further, in accordance with the identifier management method of the present invention, general users of the Internet can evaluate the reliability and usability of information with reference to the transmitter of the information and make use of the information in relief.

### BRIEF DESCRIPTION OF DRAWINGS

FIG. 1 is a view for explaining the registration of a cybername in accordance with an identifier management system of an embodiment 1 of the present invention.

FIG. 2 is a schematic diagram for showing an example of publication in a newspaper describing a list file of cybernames and public keys in correspondence with each other.

FIG. 3 is a schematic diagram for showing an example of the list file of cybernames and public keys in correspondence with each other.

FIG. 4 is a view for explaining a procedure of performing authentication with a cybername.

FIG. 5 is a view for explaining another procedure of performing authentication with a cybername.

FIG. 6 is a view for explaining the structure of the database in the management server of the embodiment 1.

FIG. 7 is a schematic diagram for showing a linking protocol implemented in accordance with the embodiment 1.

FIG. 8 is a view for explaining the mechanism of the linking protocol implemented in accordance with the embodiment 1.

FIG. 9 is a view for explaining the reliability of the date/time information (appearing in messages) associated with other information.

FIG. 10 is a view for explaining how the reliability of the date/time information (appearing in a message) is related to other information.

FIG. 11 shows an example of a BBS which makes public the messages of general users.

FIG. 12 shows an example of the message list which is displayed when clicking a URL (authentication data) contained in FIG. 11.

FIG. 13 shows the signature confirmation information provided by the identifier management system of the embodiment 1.

FIG. 14 shows the authentication date confirmation information provided by the identifier management system of the embodiment 1.

FIG. 15 shows an example of a list file of proof data which is necessary for verifying link information.

FIG. 16 shows the screen displaying messages similar to a particular message by a browser.

FIG. 17 shows a dialog for starting user evaluation.

FIG. 18 shows a dialog for generating a token.

FIG. 19 shows an example of authentication given to video and music content.

in which an original music piece named “Beyond Oblivion” is associated with a motion picture and made public as an MPEG-4 file.

FIG. 20 shows an example of a Web site which is authenticated.

FIG. 21 shows an example of a screen in which the authentication data of each file of the Web site.

FIG. 22 shows an example of an authenticated message containing the authentication data of a file.

FIG. 23 is a schematic diagram for showing a message list generated by the identifier management system of the embodiment 1 from which an email is transmitted/received.

FIG. 24 is a view for explaining quotation of an authenticated message in accordance with the identifier management system of the embodiment 1.

FIG. 25 is a view for explaining a user's favorite tab which is opened from the message list generated by the identifier management system of the embodiment 1.

FIG. 26 is a schematic diagram for showing another example of publication in a newspaper describing a list file of cybernames and public keys in correspondence with each other.

FIG. 27 is a schematic diagram for showing another example of the list file of cybernames and public keys in correspondence with each other.

FIG. 28 shows a cybername management table which is implemented in the identifier management system of an embodiment 2.

FIG. 29 shows a dialog displayed when running a signature verification program of an embodiment 3 for the first time.

FIG. 30 shows a dialog as an advanced settings screen.

FIG. 31 shows a dialog displayed when generating public key information.

FIG. 32 is a view for explaining how to disclose public key information.

FIG. 33 shows a dialog displayed if no private key file exist when running the signature verification program.

FIG. 34 is a view for explaining how to call the signature verification program of the embodiment 3 when another application is running.

FIG. 35 is a view for explaining how to add a signature to a message.

FIG. 36 is a view for explaining how to post a message with a signature.

FIG. 37 is a view for explaining how to verify the signature added to a message.

FIG. 38 is a view for explaining how to obtain the hash value of a file.

FIG. 39 shows an example of a message with the hash value of a file and a signature.

FIG. 40 shows a dialog displayed if a message includes the keyword “SHA256:” and the character string of a hash value after successfully verifying the message.

FIG. 41 shows a dialog displayed when successfully verifying the hash value.

FIG. 42 shows a dialog displayed when the verification of the hash value fails.

FIG. 43 is a view for explaining the relationship between the scenario of using a signature in accordance with the present invention and the scenario of using a signature in accordance with conventional techniques.

FIG. 44 is a view for explaining how to add a signature to a message by the signature verification program of an embodiment 4.

FIG. 45 is a view for explaining how to register a public key with a mobile terminal in accordance with an embodiment 8.

FIG. 46 is a view for explaining how to perform authentication in accordance with the authentication method of the embodiment 8.

FIG. 47 is a view for explaining how to perform identity confirmation in accordance with an embodiment 9.

### DESCRIPTION OF EMBODIMENTS

In accordance with an electronic signature algorithm, plaintext is processed by the use of a signing key to generate a signature, which can be verified by the use of a verification key. However, when storing them in a database, unique information items are to be stored. Accordingly, in this description, the key information of the verification key unique to each key pair is referred to as a public key, and the key information to be hidden of the verification key unique to each key pair is referred to as a private key. For example, in the RSA signature scheme, the plaintext c and the signature s are associated as follows.

c=ŝe mod n

s=ĉd mod n.

Namely, the signature s can be calculated from the plaintext c with d and n. Conversely, the plaintext c can be calculated from the signature s with e and n. That is, the signing key is d and n, and the verification key is e and n. Usually, e is a predetermined common constant so that n is substantially the verification key which is a public key unique to each record. On the other hand, since the verification key is public, d is substantially the signing key (private key) to be kept a secret. In the case of ECDSA, a signing key is used to generate a signature, and the verification key corresponding to a signing key can be easily calculated from the signing key.

Also, in this description, e is predetermined in the following embodiment based on RSA. Accordingly, in the following description, d is referred to as a private key, and n is referred to as a public key. Furthermore, in the following description, the process of signing plaintext is referred to as the process including the preprocess such as padding and hashing the plaintext.

### Example 1

The identifier management system according to the embodiment 1 of the present invention is implemented as a management server which manages identifiers. A utility software is installed in a personal computer of each user in order to communicate with this management server and make use of an identifier. The management server makes public a cybername of each anonymous user as a unique identifier in association with the public key of the anonymous user corresponding to this cybername. Uniqueness of each cybername is managed and guaranteed by the management server, and open to public so that anyone can confirm the uniqueness.

The utility software in the personal computer generates and saves a pair of a public key and a private key. Meanwhile, the private key is encrypted. The utility software requests the management server to register the public key in association with a cybername. The private key is not sent to the management server but hidden by the user at own risk. Also, with the utility software, it is possible to provide authentication in the name of the cybername when the user posts a message, and to verify the authentication attached to a message of another user. The signing algorithm of this embodiment is based on the 2048-bit RSA.

The communication between the management server and each user is protected by SSL which includes TLS (Transport Layer Security). Particularly, although not necessary, it is preferred to perform client authentication. In this case, the public key associated with a cybername may be readily used.

The basic function of the identifier management system makes it possible that Internet users can use electronic signatures without need for disclosing personal information. For this purpose, the identifier and public key of each user are registered and made open to public. Each user can clearly distinguish own identity from other users by providing electronic signatures to activities that user performs and establish an Internet identity associated with own identifier.

<Registration of a Cybername>

A cybername is registered on an anonymous basis in accordance with this embodiment. In this case, if one user registers a number of cybernames, available cybernames may be exhausted. Accordingly, some mechanism is needed to avoid unnecessary registration. This purpose can be achieved, for example, by a CAPTCHA system which displays distorted unclear characters which can hardly be read by a machine, and requires that the user type the characters. Also, restrictions may be imposed when registration is requested from the same IP address, or by making use of cookies.

The utility software for cipher processes is used to handle cybernames. The functions implemented within this utility software include the function of generating public and private key pairs, the function of converting these keys into Base64 strings, the function of encrypting and saving a private key with a password, the function of generating a signature on data with a private key, the function of converting the signature into a Base64 string.

Furthermore, in this embodiment, the utility software serves also as a simple browser. This simple browser makes it easy to transmit a message with a signature. However, this browser function is dispensable. The procedure without using the browser function will also be explained below. Incidentally, the utility software has the function of printing a public key and a private key in Base64 strings for missing of these keys.

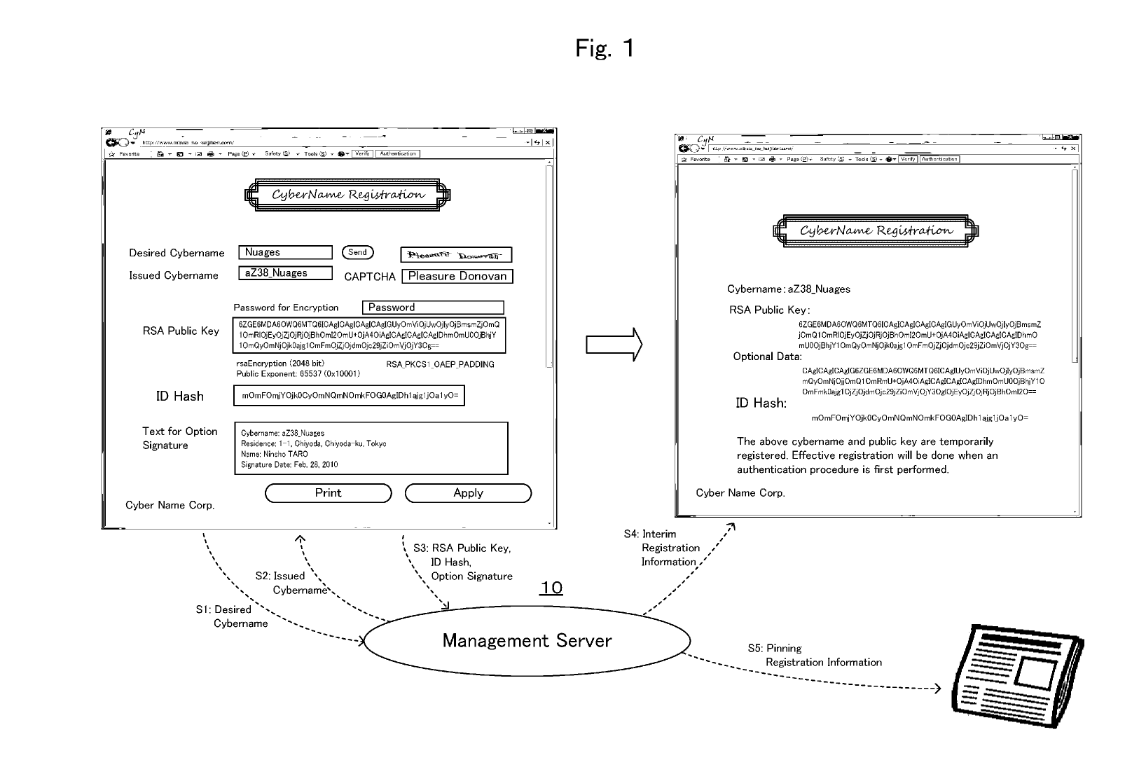

In what follows, the registration of a cybername will be explained with reference to FIG. 1. FIG. 1 shows a screen of the utility software in accordance with this embodiment. The identifier management system includes a management server 10. A user desiring registration of a cybername inputs a desired cybername and clicks a transmission button to transmit the desired cybername to the management server 10. The management server 10 returns a cybername which can be issued (S2). The issued cybername is displayed in a box for displaying the issued cybername. Also, at the same time, the management server 10 transmits image data of a distorted character string of the CAPTCHA. This image data is displayed on the screen of the utility software. The user reads and input this character string in an input box located below.

The issued cybername is made up by attaching a prefix to the beginning of the input cybername. This prefix is a hash value given for the purpose of obtaining a unique cybername and selected by the management server 10 in order to prevent the cybername from being similar to another cybername. The prefix is attached with a tail of an underbar. For example, in the case of the example shown in FIG. 1, the user inputs “Nuages” as the desired cybername, and the management server 10 returns “aZ38_Nuages” as the issued cybername.

By this configuration, a plurality of users can use cybernames in the forms of “****_Nuages”. In the case of this example, there are 16,777,216 prefixes consisting of four Base64 characters. A prefix is clearly separated from a desired cybername by an underbar “_” so that the number of characters of a prefix need not be fixed.

Also, the utility software calculates a pair of public and private keys in accordance with RSA. The user inputs a password for encrypting the private key. Furthermore, text for option signature may be input if the user desires. The usage of this text is described latter. Still further, the utility software generates a 256 bit random number which is displayed as a confirmation hash value (ID Hash). The usage of this hash value is also described latter.

After completing the input and clicking an application button, the cybername is transmitted to the management server 10 together with the RSA public key, the input CAPTCHA character string, the optional data and the confirmation hash value (S3). In this embodiment, however, the optional data which is transmitted is a 2048 bit signature which is generated on the text for option signature. If the received CAPTCHA character string is correct, the management server 10 saves the received information in association with the cybername together with the current date/time as an interim registration date, and returns interim registration information to the user (S4).

The user confirms the interim registration information, and can thereafter use the cybername. When the cybername is first actually used to create a user signature, the interim registration becomes an effective registration at this time as a fixed registration date. If such a user signature is not created within one week after the interim registration, the interim registration is made invalid and deleted. In this case, the user has to take the same steps again.

Incidentally, since the prefix is determined by the management server 10 in this example, step S1 and step S2 are performed first. However, the utility software may determine a prefix by generating a random number and dispense with step S1 and step S2. In this case, the cybername with the prefix is transmitted in step S3. If the cybername has been already used, the management server 10 notifies the utility software of this fact.

<Option Signature>

The management server 10 also registers the optional data transmitted from the user and made open to public. This optional data can be used, for example, for the following purpose. Namely, as illustrated in FIG. 1, personal information which can identify the user is input to the utility software. When the above data is transmitted to the management server 10, the utility software transmits the signature on this personal information as the optional data. The optional data does however not include the personal information itself but only consists of a 256-bit RSA signature. In this case, the personal information is processed by a hash function in advance so that the personal information cannot be obtained from the signature. Accordingly, even if the signature on the personal information is open to the public, anonymity can be maintained.

On the other hand, since the signature itself has been registered in association with the cybername and the public key, it can be certified who is the owner of the cybername whenever the owner desires. Namely, it can be certified by disclosing the above private information which corresponds to the registered signature. The maximum size of optional data corresponds here to 44 half size characters corresponding to 256-bit RSA signatures.

For example, the optional data can be used to identify the owner of the cybername when the private key corresponding to the cybername is lost or leaked. The plaintext which is signed may be lost, so that a recommended common form may be predetermined. FIG. 1 shows, in an “text for option signature” block, an example of a plaintext which is prepared in accordance with such a common form where the input data is 2010/02/28, the residence is “1-1, Chiyoda, Chiyoda-ku, Tokyo”, the owner name is “Taro NINSHO” and the cybername is “aZ38_Nuages”, which are concatenated as identity confirmation text which is displayed in the text box for option signature of FIG. 1. Even when all the data at the user end is lost by any chance, it is possible to confirm that the user is the owner by reconstructing the text in an automatic manner and verifying the option signature on the text.

Nevertheless, when such a common form is used, there may be undesirable cases. For example, if there are several candidates of the real name corresponding to a cybername, the real name may be identified by a brute-force attack, i.e., by repeatedly verifying the option signature on the reconstructed text corresponding to each candidate. In such a situation, it is desirable to prepare identification text in an unspecified manner. One of the secure methods is to prepare the optional data by adding a random number or a optional hash to personal information.

On the other hand, if the information is stored as electronic data, there is the possibility that the data is stolen, lost or corrupted. Generally speaking, for example, the above risk can be avoided by printing all the registration information such as a private key, identification text and so forth on paper, and storing the paper in an appropriate place.

<Option Hash>

In the case where a private key is leaked or the like so that a plurality of users can sign with the same cybername, it is possible to identify the first person if a hash value has been registered as optional data in advance.

Namely, a random number or the like is processed recursively (for example thousand times) with a hash function such as SHA-256, and registered as optional data. Since it is a rare case where owner identification is required, the first random number or the like is stored in an external storage such as a USB memory or printed in paper.

The owner identification can be performed by providing the preimage of the registered optional data. When updating the registration of a cybername, while the public key cannot be changed, the optional data can be changed. Accordingly, it is repeatedly possible to performs owner identification by replacing the optional data with the preimage which is disclosed. Also, in this case, the owner identification is performed as identification of the user who has registered first.

<Pinning Registration Information>

The records of the management database is made public on a dedicated site, and anyone can obtain the public key corresponding to a cybername. Also, the records registered in a predetermined period can be downloaded as a file. For example, cybernames registered within a period of one week are made public as a list file such as a CSV file together with public keys, registration dates and option signatures in association with the cybernames respectively in order that this file can be downloaded. The hash value of the list file is then published in a publication such as a newspaper. This is called here pinning registration information (S5).

Namely, in this description, “pinning” is a procedure for objectively fixing the one-to-one correspondence between public keys and cybernames, which are made open to public as digital data, by means of information printed on the publication which cannot be altered. However, the fixing of the one-to-one correspondence is depending upon the effectiveness of the cryptography so that the pinning procedure is performed again when the need arises.

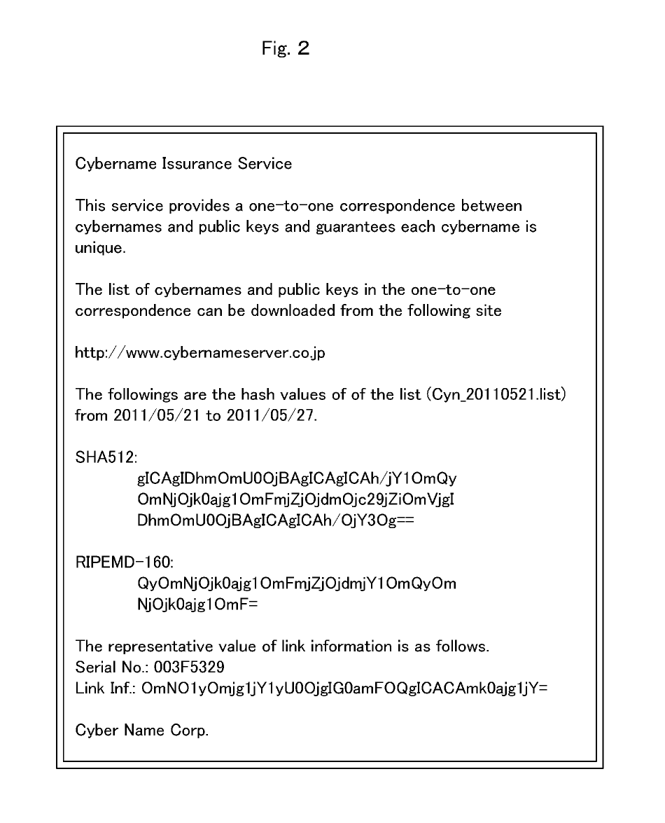

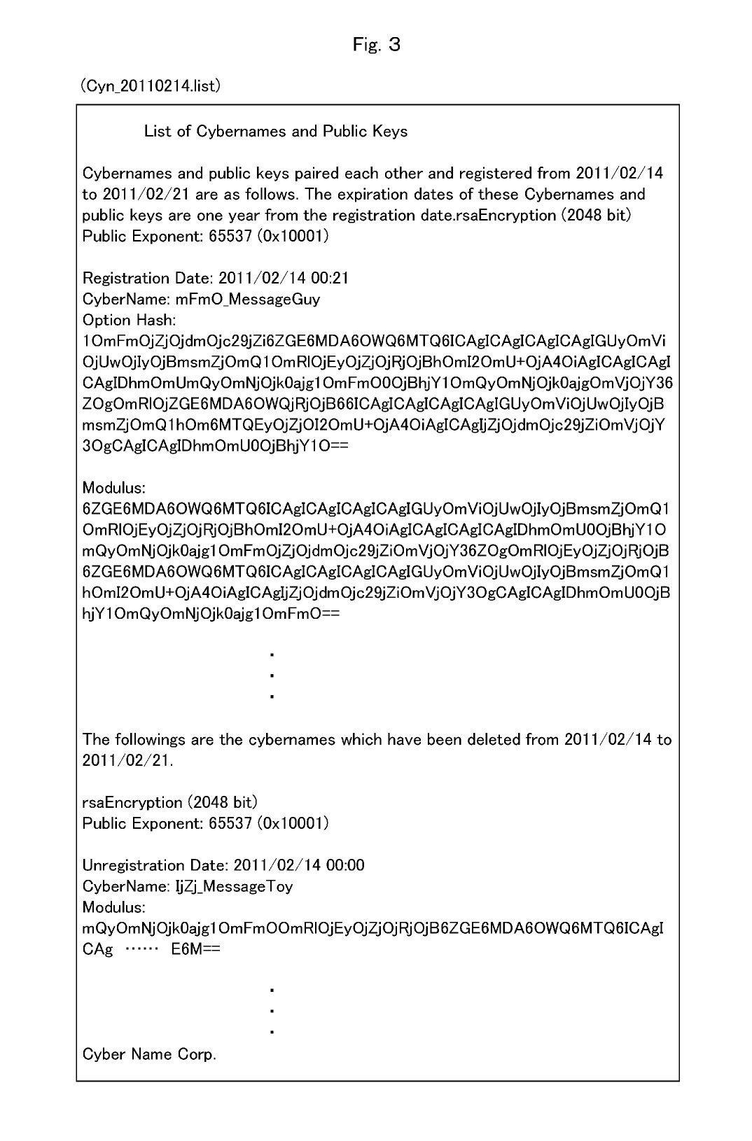

An example of publication in a newspaper is shown in FIG. 2. Also, an example of the list file is shown in FIG. 3. The example shown in FIG. 2 contains two hash values. Even when one of the hash values is invalidated, the other validity can be maintained. Also, a representative value of linking information is made public. This representative value will be explained below in detail.

Accordingly, the owner of the private key corresponding to a cybername (the user of the cybername) can certify that the user is the owner of the cybername at any time independent of the management server 10 by saving the list file. The validity of this list file is guaranteed in a period in which the security of the hash function is confirmed. That is to say, the combination of the list file and the publication serves as a public key certificate of the cybername.

<Cybername Authentication 1>

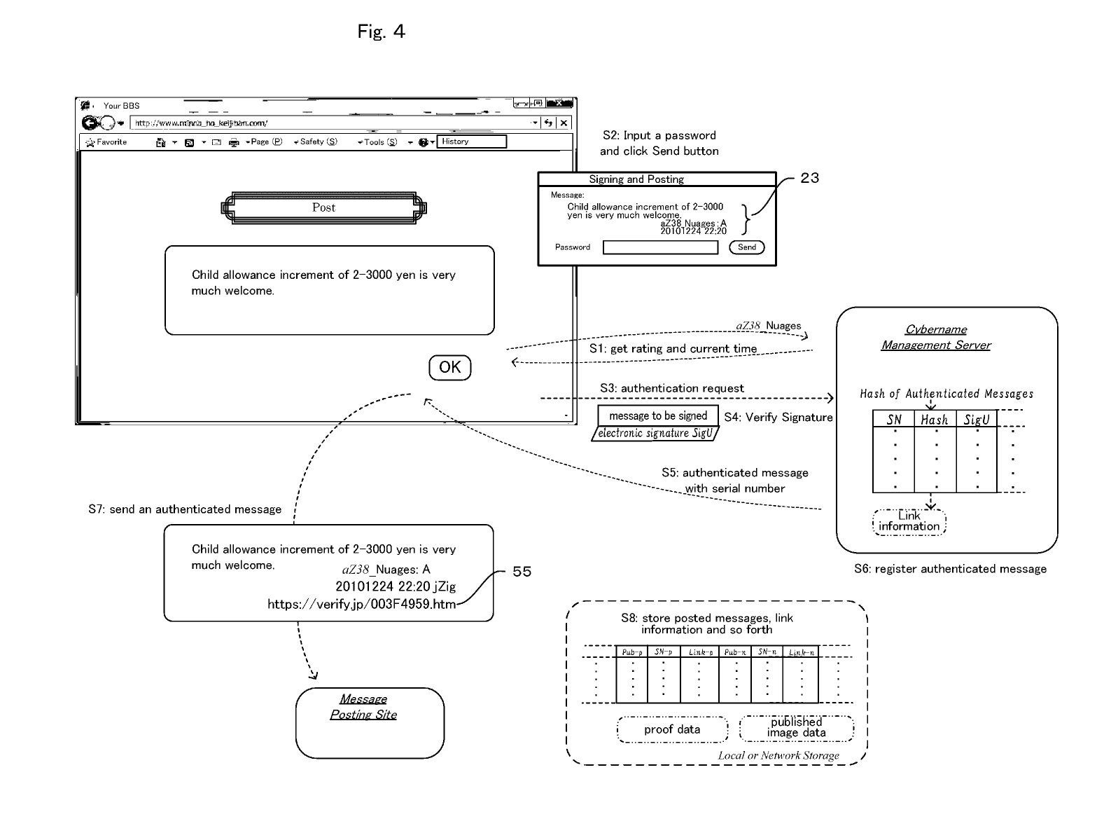

After completing registration of a cybername, the user can attach authentication to an opinion or information which is posted to a Web site serves as a BBS. The aforementioned utility software is implemented with a simple browser function which can be used when information is transmitted with authentication. The use of authentication will be explained with reference to FIG. 4 showing an edit box of a BBS site to which a message “Child allowance increment of 2-3000 yen is very much welcome” is posted.

First, the utility software opens an posting page of the BBS site (a page to which information can be posted). The user writes a message in the edit box and clicks a send button. The utility software first sends the cybername to the management server for requesting authentication. If the expiration date of the cybername is passed, the management server notifies this fact and finish the process. If the expiration date of the cybername is not passed, the management server returns the rating (to be described below) of the cybername together with the current time (S1).

Then, the utility software displays a pop-up window including a password box together with the message 23 to be signed (S2). In this case, the message 23 to be signed includes the cybername, a rating (‘A’ in this example) and the current date/time in addition to the message written by the user. The rating serves to provide an indication of the reliability of the user and placed after the cybername with ‘:’ therebetween. The date/time are acquired from a timeserver each time.

The user confirms the content, enters a password, and clicks an OK button. The utility software decrypts an encrypted private key by the use of the password, and signs the message including the cybername, the rating and the current date/time, and transmits the message and the signature to the management server as an authentication request (S3). In addition to this, the utility software transmits the information of the site to which the message is to be posted together with the authentication request. This URL is used in a message list to be described below as the information indicating the site.

After receiving the authentication request, the management server verifies the received user signature (S4). If the verification fails, the management server notifies this fact and finishes the process. Conversely, if the verification succeeds, the management server assigns a serial number to the message, inserts a seal to create an authenticated message, which is returned to the utility software (S5), and registers the authenticated message (S6). The utility software posts this authenticated message to the site (S7).

As illustrated in FIG. 4, the serial number is included in this authenticated message as part of an URL 55. This serial number is assigned to each message of all the users in order that all the messages are arranged in order of time, and represented by hexadecimal numerals (e.g., “003F4959” in FIG. 4). In addition, a seal is calculated from the user signature and inserted after the authentication date (current date/time). This seal can be used as a physical seal of the user.

As described below, the serial number is associated with the hash value of the authenticated message corresponding thereto and serves as authentication data for the message. In other words, the management server confirms and authenticates the facts that the user signature is generated corresponding to the cybername, and that the authentication date/time as shown is correct.

Accordingly, the authentication of a message can be confirmed by transmitting an inquiry with the authentication data to the management server. The procedure will be explained later. When the authentication is confirmed, it is based on the reliability of the management server. More exactly speaking, anyone can objectively verify a signature and authentication date/time by the use of a public key and link information after the pinning procedure. The procedure will also be explained later.

The data items necessary for certifying the authentication date/time of a message is stored in the management server, and preferably stored also in the user side (S8). In other words, the user can store an entry corresponding to the message stored in a message management table 62 of the management server to be described below. Furthermore, when available, the image data of the subsequent publication in a newspaper is downloaded from the management server as the link information together with a set of hash values (proof data) associated with the message. This makes it possible to certify the authentication date/time of the message independent of the management server.

<Cybername Authentication 2>

The utility software and the management server can be implemented in a more simple fashion. In this implementation, an posting page of the BBS site is opened in a usual browser. Namely, as illustrated in the upper right of FIG. 5, an posting page is opened by a browser which is regularly used. If a user wants to use authentication at this time, the signature authentication window of the utility software is opened (the upper left of FIG. 5). This signature authentication window includes an edit box in which a message can be written and a password input box.

The user writes a message in the edit box and enters a password followed by pressing a button to start the signing process. The utility software then acquires the current time from a timeserver on the Internet, and generates a message to be signed by adding the current time and the cybername to the input message. The utility software generates a signature by signing this message to be signed, and transmits an authentication request together with the signature and the message (S1).

When receiving the authentication request, the management server verifies the user signature as received (S2). If the verification fails, the management server notifies this fact and finishes the process. Conversely, if the verification succeeds, the management server assigns a serial number to the message, inserts a seal and a rating to be described below to create an authenticated message, which is returned to the utility software (S3), and registers the authenticated message (S4). Namely, the utility software and the management server exchanges data only for once.

The utility software copies this authenticated message to a clipboard, and displays for example “The authenticated message is stored in the clipboard, and can be used by pasting it to a site for posting”. The user posts the authenticated message to the site after pasting it to the edit box from the clipboard. As has been discussed above, the utility software saves the authenticated message and the data items necessary for certifying the authentication date/time of the message.

In this example, while the utility software need not have a browser function, the user has to take more steps. Also, since the site information (URL) of the posting target can not always exactly be acquired through a usual browser, this site information is treated only as a reference. Furthermore, in this example, the message to be signed does not include a rating. This is effective to save the communication cost with the management server.

<Seal>

After receiving and verifying the user signature, the management server calculates the hash value of this user signature, and generates a seal of four characters by Base64 encoding the least significant 24 bits of the hash value. This hash function is for example SHA-1. This seal is added to the end of the authentication date/time (the current date/time).

A seal can be considered appropriately as a 24-bit random number and thereby as a hash value of the user signature. It is not impossible to generate other data which has the same length and the same 24-bit hash value as the user signature. However, it is impossible to create an authenticated message which is the preimage of the other data and can be successfully verified with the other data as the user signature.

Accordingly, a user can certify, independent of the management server, that an authenticated message has been posted by the user and that an authenticated message has not been posted by the user. Namely, a user can certify the ownership of the cybername by generating the signature on the message and confirming the correspondence between the signature and the seal. Conversely, if the signature and the seal does not correspond to each other, it is certified that the signature is not generated by the user. Matching of the cybername and the public key can be certified by the list file and the published information on a newspaper.

<Message Management>

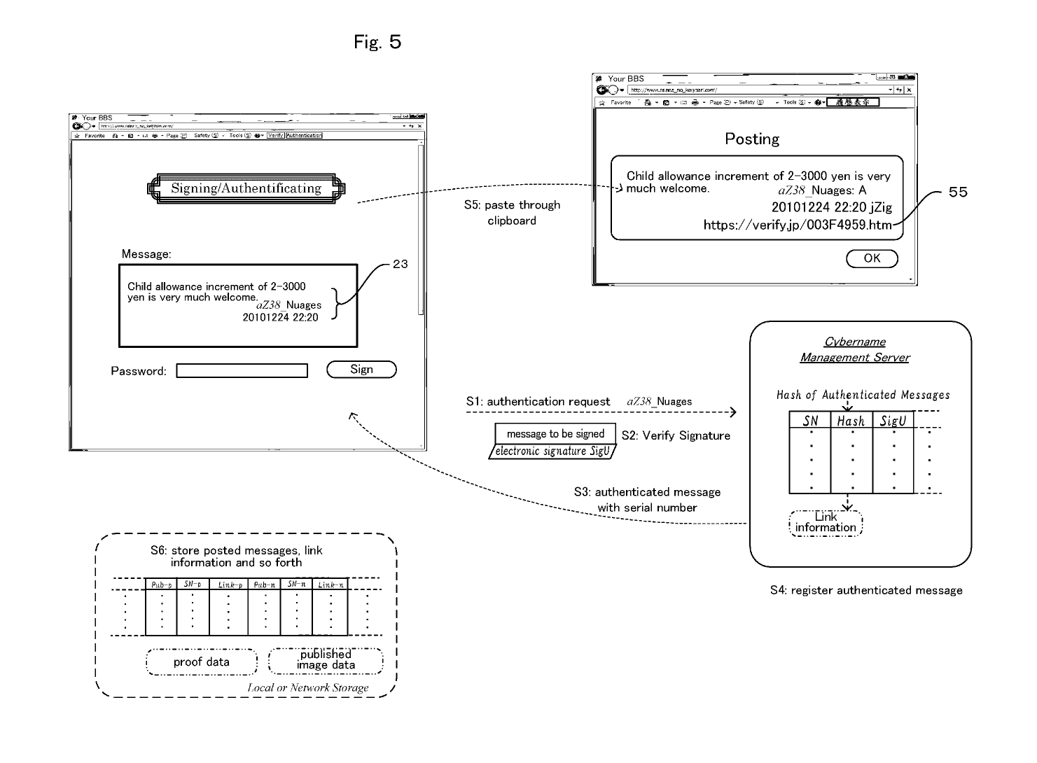

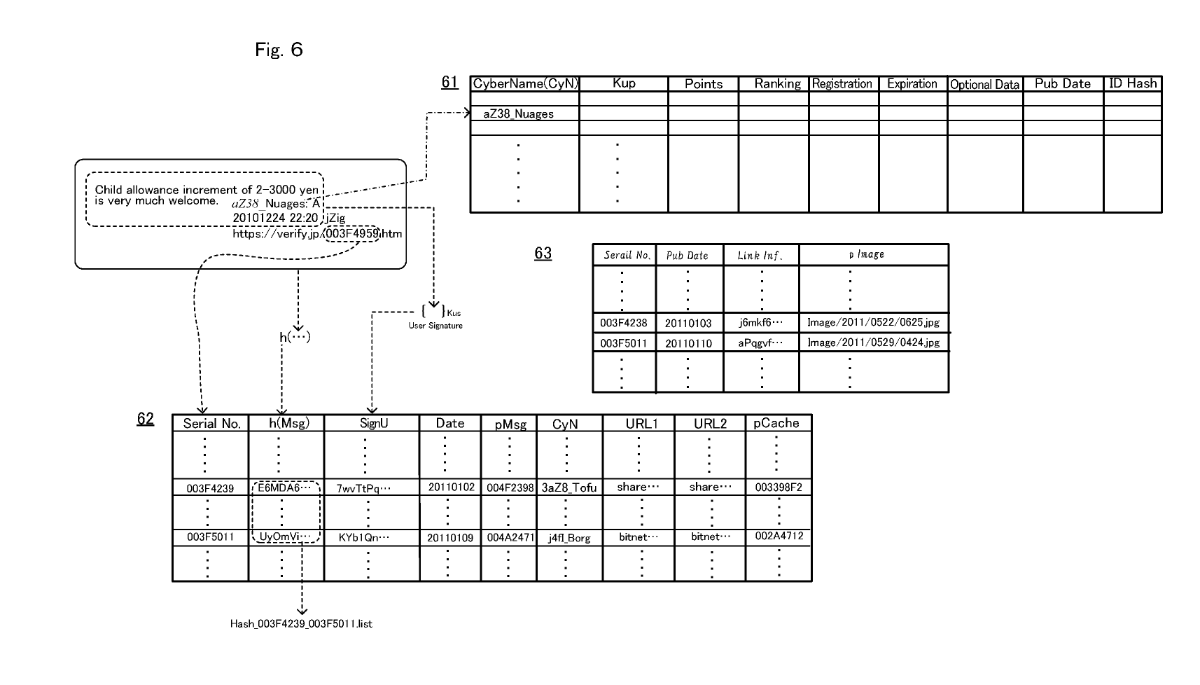

As illustrated in FIG. 6, the database of the management server contains a cybername management table 61 for associating cybernames with user public keys, the message management table 62 for managing all the authenticated messages in order of time, and a public link information table 63.

The cybername management table 61 includes, for each entry, fields for storing a cybername (CyN), a user public key (Kup), a number of points (Points) indicative of the reliability of each user, ranking information (Ranking), a registration date (Registration), an expiration date (Expiration), an optional data item, a publication date (Pub Date), and a confirmation hash value (ID Hash).

The cybername management table 61 is provided for associating cybernames with user public keys in a one-to-one correspondence. The points is indicative of the reliability of each user. The ranking information (Ranking) is indicative of the reliability of each user in relation to the others. The optional data can be used, e.g., when the owner of the cybername certifies the ownership of the cybername by the use of the real name. The confirmation hash value can be used to repeatedly and easily perform identity confirmation on an anonymous basis. The functionality and usage of these fields will be explained later in detail.

Each entry of the message management table 62 contains fields including a serial number (Serial No.) assigned in order of time when creating an authenticated message, a pointer (pMsg) which points to the address where the authenticated message is stored, the hash value h(Msg) of the authenticated message, the user signature SigU on the message to be signed, the authentication date/time (Date) of the authenticated message, and a cybername CyN.

The message to be signed is the message body suffixed with a cybername, a rating and an authentication date/time. The user signature SigU is the signature generated by the user on this message to be signed as described above. Also, as described above, the authenticated message is the message to be signed suffixed with a seal and a URL containing a serial number. However, in the case of the above <Cybername Authentication 2>, the rating is not contained in the message to be signed, but inserted when the authenticated message is generated.

Incidentally, the message management table 62 of this example includes a field URL1 for storing the URL of a posting page which is transmitted from the user. The message management table further includes a field URL2 for storing the URL of a page where the authenticated message can be read, and a field the pointer pCache to this page stored in the cache of the management server. These URLs 1 and 2 are used in a message list to be described below.

The serial number is one of the consecutive numbers assigned to all the messages arranged in order of time. The timely relationship among the messages can be determined by the serial numbers. As described below, the representative value of the link information generated with the serial number as the time series ID is published together with the hash value of the aforementioned list file in a publication such as a newspaper (FIG. 2).

The public link information table 63 contains fields including the serial number published in the publication, the date/time of the publication date (Pub Date), the link information and the image data (p_Image) of the published information. Anyone can request the link information relating to the data associated with a serial number by accessing the management server and designating the serial number, and download the associated data, i.e., the entries of the public link information table 63 having serial numbers between which the requested serial number is located, and the hash values between the serial numbers of the entries.

The date/time (Pub Date) of the public link information table 63 is the same as the publication date (Pub Date) of the cybername management table 61. Namely, each entry of the cybername management table 61 includes, as the publication date (Pub Date) thereof, the date of the publication (newspaper) in which is published the hash value of the list file containing the cybername of the each entry. Because of this, while a plurality of cybernames can share the same publication date, the entries of the public link information table 63 have different date/time (Pub Date) values. The public key of aZ38_Nuages can thereby be confirmed by obtaining the publication date of aZ38_Nuages from the cybername management table 61, and then acquiring the image data (p_Image) corresponding to this publication date from the public link information table 63. This image data should contain the public key of aZ38_Nuages.

For example, in the case where the user wants to the data relating to the serial number “003F4959”, the user can download the data relating to the serial number “003F4238”, i.e., the date/time of the publication, the link information, and the image data which is made public, and the similar data relating to the serial number “003F4239” as well as the file “Hash_{—}003F4239_{—}003F5011.list” containing the hash values of the authenticated messages from the serial number “003F4239” to the serial number “003F5011”.

The link information of this example published in the publication of 2011/01/03 is the link information obtained from the hash value of the last authenticated message dated 2011/01/01. In other words, the link information and so forth obtained from the hash value of the last authenticated message dated 2011/01/01 is transmitted on the date of 2011/01/02 to the publisher of the publication to publish the same data in the publication dated 2011/01/03.

The management server verifies a user signature and assigns a serial number to the message corresponding thereto. Accordingly, the serial number added to the message is the authentication data indicating that the message has been authenticated.

Also, anyone can acquire other information by accessing the management server. For example, anyone can acquire all the information of any entry of the cybername management table 61 by specifying a cybername. Furthermore, anyone can acquire all the information of any entry of the message management table 62 by specifying a serial number.

For example, it is assumed that a user wants to confirm the public key of aZ38_Nuage on the basis of published information. In this case, first, the publication date (Pub Date) of aZ38_Nuages obtained from the cybername management table 61 is confirmed with reference to the list file which should contain the public key of aZ38_Nuage. Next, it is confirmed that the hash value of the list file equals the hash value appearing in the public data dated just after the publication date. By this process, the public key of aZ38_Nuages can be confirmed as the correct key.

<Date/Time Authentication>

Timestamp is generally used as a means for performing time authentication given to electronic data. This timestamp is also used in the electronic signature law and electronic notary system. There are ministerial ordinances which require timestamps for some official documents which are acceptable in electronic forms under the electronic document law. As an implementation of timestamping, the linking protocol is widely used. This linking protocol makes it possible to certify, for a long period, the date and time at which a particular electronic document is provided and not altered thereafter without resorting the reliability of electronic signatures.

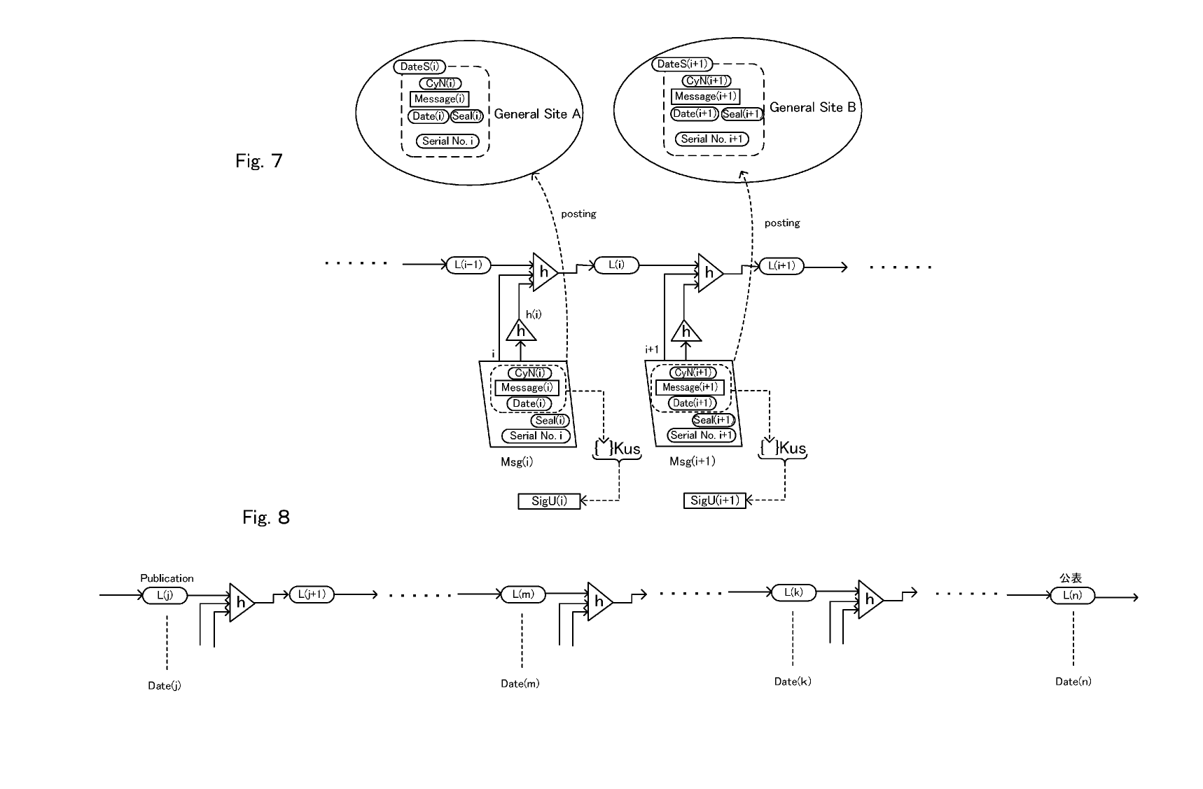

In what follows, with reference to FIG. 7, the time authentication of the present embodiment will be explained. If “i” is a serial number, the timely relationship between the authenticated message Msg(i) and the authenticated message Msg(i+1) can be determined by the link information L(i), the previous link information L(i−1) and the subsequent link information L(i+1).

That is, the link information L(i) is the information that is calculated from the link information L(i−1) and the authenticated message Msg(i). The linear linking protocol is used here. Namely, while a hash function is written as h( ) the link information L(i) is a number which is calculated as L(i)=h(L(i−1), i, h(Msg(i))). The authenticated messages are thereby connected to each other in the form of a chain by the link information.

The characteristic of the hash function guarantees that the link information L(i−1) and the authenticated message Msg(i) shall precede the link information L(i). Likewise, the link information L(i) and the authenticated message Msg(i+1) shall precede the link information L(i+1).

As long as the link information L(i−1), L(i) and L(i+1) and the authenticated messages Msg(i) and Msg(i+1) are consistent with each other, the authentication date/time Date(i) of the authenticated message Msg(i) shall precede the authentication date/time Date(i+1) of the authenticated message Msg(i+1). If Date(i)>Date(i+1), at least either date/time shall be wrong.

Referring to FIG. 8, explanation will continue. The link information L(j) and the link information L(n) are representative values published in a publication such as a newspaper. All the authenticated messages between the link information values always satisfy Date(j)>Date(k)>Date(n) where j<k<n. If the authentication date/time Date(k) of the authenticated message Msg(k) is surely correct, it shall be correct that Date(j)>Date(m)>Date(k) where j<m<k<n.

This linear linking protocol is one of timestamp protocols used for timestamp services. However, this embodiment has a higher reliability than usual timestamp services as a timestamp system.

Usual timestamp services guarantee that a hash value which is substantially a random number has been provided on a particular date/time. The content itself corresponding to the hash value is owned by the user but not open to public. On the other hand, the timestamp service makes public the hash values but has no concern with the content itself.

Also, in the case where the representative value is published every week, the linear linking protocol does not guarantee the true authentication date/time in the period of one week. The order relationship among the timestamps is only guaranteed in the week. The authentication date/time itself depends upon the reliability of the timestamp service provision site.

As has been discussed above, also in the case of the present embodiment, the representative value of the link information generated with the serial number as the time series ID is published together with the hash value of the aforementioned list file in a publication such as a newspaper (FIG. 2). However, the authenticated message Msg(i) is stored in and managed by the management server, and seen at the general sites which make it public.

If the authenticated message Msg(i) is made open to public, the hash value thereof is effectively made open to public. This hash value serves as proof data for connecting the published link information values.

In the case of the present embodiment, the authenticated message is made public together with the posting date/time at the general sites in addition to the authentication date/time which is given by the management server. The probability that the authentication date/time is correct becomes higher by public data at the general sites which are third parties. If there is an authenticated message dated at a reliable site between the publication dates of the adjacent representative values and the hash value and the posting date/time are consistent with the link chain, the reliability of the authentication date/time is enforced by the posting date/time of the reliable site.

Accordingly, the management server makes open to the public the hash values of the authenticated messages between the publication dates of the adjacent representative values together with the URLs of the posting sites in order that these hash values can be downloaded. Also, the image data of published information as shown in FIG. 2 and the bibliographic items are made public. If desired, any user can save evidence data which can be used to certify the posting date of an authenticated message by saving the list of the hash values and the published information.

Incidentally, as shown S8 in FIG. 4, the user can store the two necessary representative values Link-p and Link-n, the serial numbers SN-p and SN-n and the publication date Pub-p and Pub-n for each own message. The user also stores a set of the hash values (proof data) between the two adjacent representative values Link-p and Link-n and the image data of published information. It is therefore possible to certify the authentication date/time of the message independent of the management server.

<Availability of Link Information>

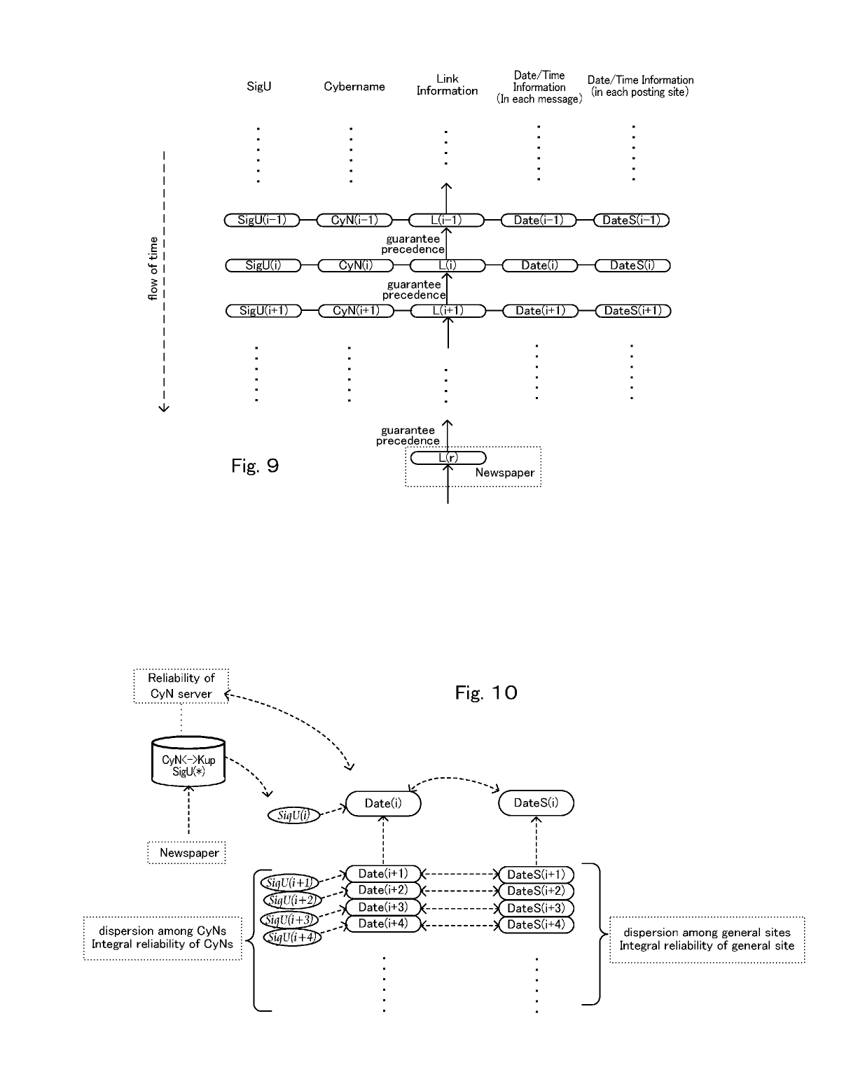

Next is detailed explanation of how the link information is related to the reliability of the authentication date/time. FIG. 9 shows the time series of cybernames, user signatures, link information, date/time information (given by the management server) and date/time information (given at the general sites). makes public the information These information items are made public at the posting sites. The management server also makes the information items public so that it is easy to follow links. The link information is not directly made public at the posting sites. However, the link information can be calculated from the representative value on the basis of the hash values of the authenticated messages.

FIG. 10 shows how the reliability of the date/time information (appearing in a message) is related to other information. The characteristic of the hash function guarantees the timely relationship (order) among the authenticated messages on the basis of the link information. In what follows, it is assumed that the message having the date/time information Date(i) has been made public at a certain site.

This site gives this message with the date/time information DateS(i) which is assigned irrespective of the date/time information Date(i). The reliability of the date/time information Date(i) and the reliability of the date/time information DateS(i) are complementary with each other. That is to say, Date(i) and DateS(i) are in a one-to-one correspondence.

Since the timely relationship among the authenticated messages is guaranteed by the link information, if Date(i)>Date(j) and i<j, at least either date/time information shall be wrong. In such a case, it is very likely that, of Date(i) and DateS(i), the date appearing questionable in the message chain is wrong.

For example, it is assumed that the date/time information of a message is falsified to one week ago. It is first needed to falsify the data in the management server by hacking the management server or through some inside accomplice. If the date/time information Date( ) of the message is falsified to the date/time information one week ago, the date/time information Date( ) appears solely out of the monotone increasing date sequence in the message chain of the week.

It is therefore required to reconstruct the message chain itself. A new one-week message chain has to be created after deleting the original one-week chain such that the new message chain is smoothly connected to the previous one-week chain. In this case, the messages of the original chain have to be deleted by hacking the posting sites. Furthermore, the messages of the new chain have to be written in the posting sites. Still further, it may be needed to hack the personal computers of the users to establish the consistency. Such a process seems impractical.

Namely, the management server, each user having posted a message, each posting site making public the message are considered independent from each other with respect to the date/time information. When the date/time information seems questionable, it is easy to estimate which date/time information is false on the basis of the one-way functionality of the hash function. Also, it is clear where the cause of the problem exists. Accordingly, except for unintentional errors, there is little possibility that a fraudulent attempt succeeds.

<Embedding Link Information>

The link information can be embedded in a message. However, if all the link information is embedded in a message, it appears heavy for the message. The aforementioned seal is therefore used for this purpose.

The link information L(i) can be calculated as described above as L(i)=h(L(i−1), i, h(Msg(i))). It is assumed here that the link information consists of 256 bits. In this case, L(i) is divided into 24-bit chunks L(i, j) from the lowest bit, where j=0 to 10 and the last chunk is filled with 0 after the 16-th bit thereof. The chunk L(i, j) is encoded by base64 and inserted into the subsequent message Msg(i+j) as a seal. By this configuration, the link information is made successively public.

<Verification of Authentication>

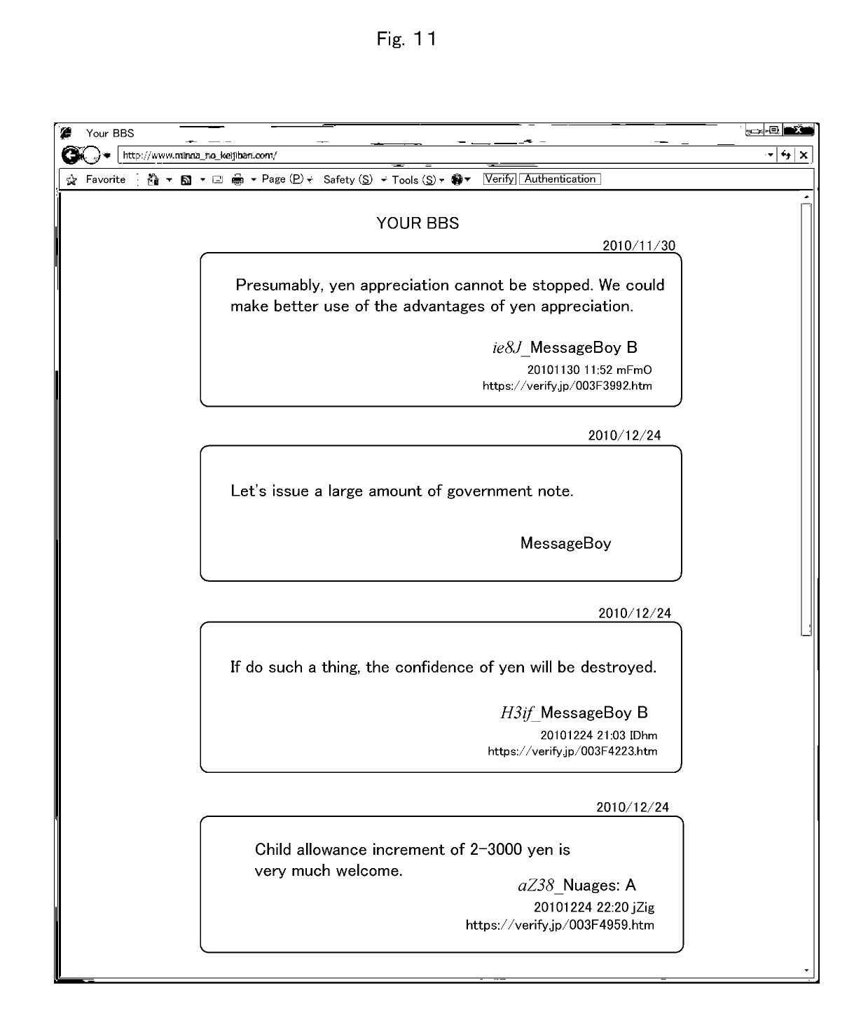

FIG. 11 shows an example of a BBS which makes public the messages of general users. The browser shown in the figure can be a general browser. As described above, the authenticated message includes a URL containing a serial number. The domain name of this URL is of the management server. When receiving this URL, the management server returns an html file containing the registered message corresponding to the serial number in the management server.

For example, when requesting the URL contained in the fourth message as shown in FIG. 11, i.e., when requesting the URL contained in the message of the cybername aZ38_Nuages, the management server receives a serial number of “003F4959”. The management server returns a message list as a response in which are displayed the messages of the serial number “003F4959” and the messages of the serial numbers therearound.

If the character string of a message includes a URL, many sites automatically converts this URL to a link to this URL. Accordingly, in many cases, the message list can be displayed only by clicking the URL. If a URL is not converted to a link to the URL, the message list can be displayed by opening the URL.

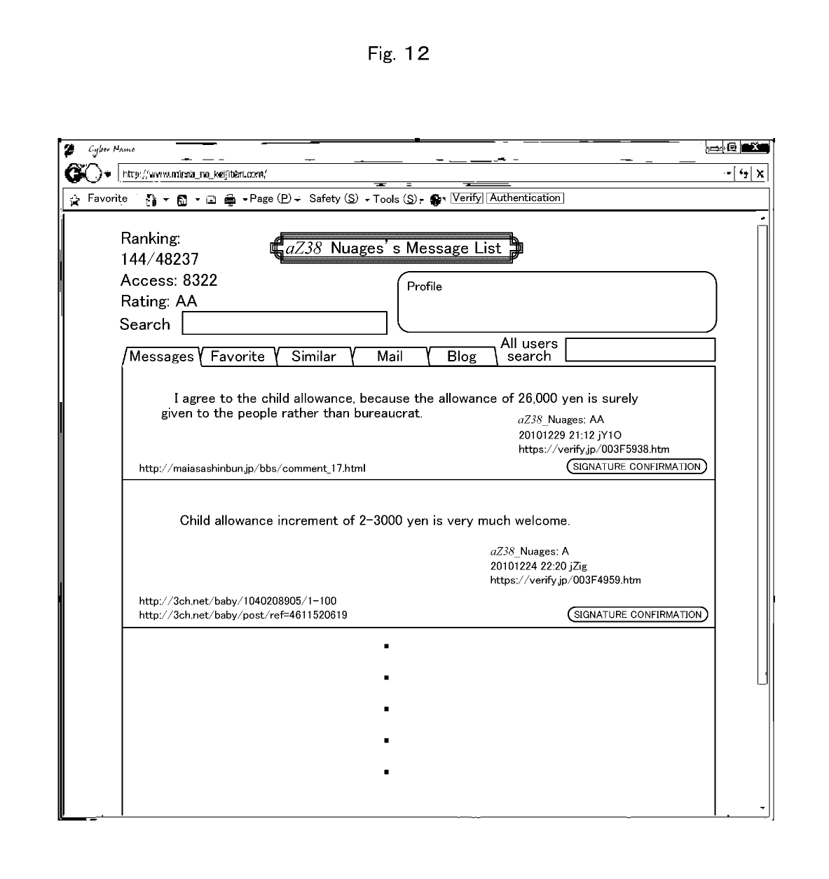

FIG. 12 shows an example of the message list. This message list shows a series of past authenticated messages of the posting user (aZ38_Nuages in this case). In the case where there are a substantial number of messages to be listed, the personality of the user corresponding to aZ38_Nuages can be known to some extent, for example, by searching the messages. Each entry of the list includes the link to the site which makes public the message contained in the entry.

This link is the URL1 which is acquired from a browser during authentication as described above, and thereby not necessarily the direct link to the correct page in which the authenticated message appears. If the URL2 to the correct page in which the authenticated message appears is available, it is displayed together.

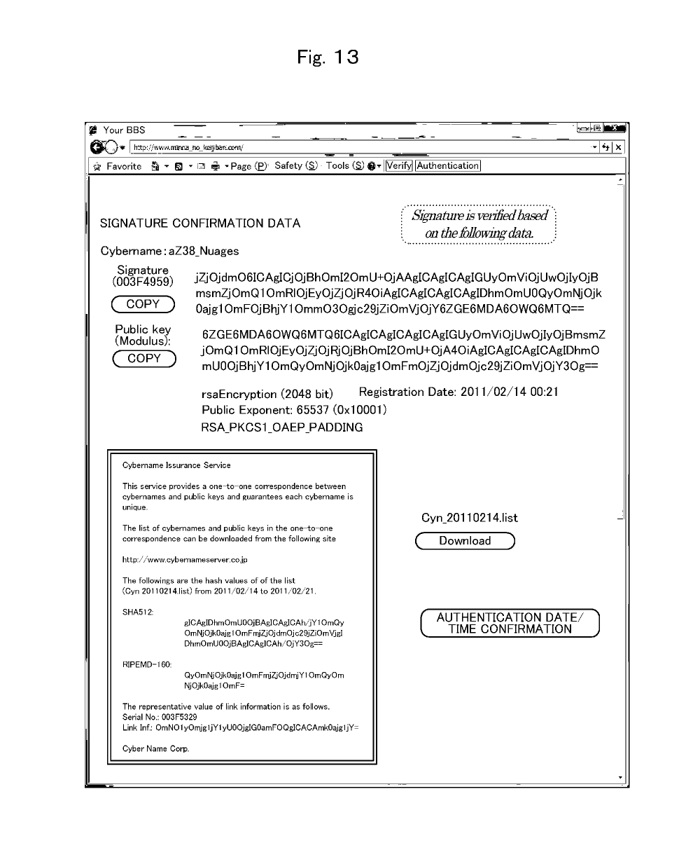

Accordingly, if the message appearing in the BBS matches the message corresponding to the serial number “003F4959” displayed in the message list, it is confirmed that the message has been authenticated by the management server. When directly confirming that the message corresponding to the serial number “003F4959” is posted by the user corresponding to the cybername aZ38_Nuages, a signature confirmation button is clicked. Then, the screen is switched as shown in FIG. 13. This screen includes the user signature on the message corresponding to the serial number “003F4959”, the public key of the user, a button for downloading the list file containing this public key, and a copy of the newspaper publishing the hash value of the list file.

Accordingly, the signature is verified on the message from which the rank and the serial number are removed after verifying the list file with reference to the hash value published by the newspaper, and confirming the public key of the cybername contained in this list file. It is objectively confirmed that the message has been written by the user who owns the cybername with its private key.

The management server searches for a web page in which each authenticated message is made public. The web page can be found by searching the web with the cybername, the serial number and words contained in the authenticated message. However, when using a general search engine which takes several days to a week or longer for reflecting the authenticated message in indice as routine update, the process searching for an authenticated message is performed a while after authentication of this message. The URL2 of the web page can be obtained. As illustrated in the second message of the list shown in FIG. 12, the URL2 is displayed above the URL1 obtained from the browser during authentication. Accordingly, if there are two URLs, the web page can be directly displayed by clicking the upper URL.

Alternatively, the web page can be displayed by a user. An link to the URL of a search engine with the above search terms is placed on the message list shown in FIG. 12. The user can display a page of the search engine containing the search result by clicking the URL. If the authenticated message has already been reflected in the index of the search engine, the search result page contains the authenticated message.

The additional link is, for example, “http://www.websearch.co.jp/web?q=Child+allowance+2-3000+increment+welcome+aZ38_Nuages” in the case of the above example of “Child allowance increment of 2-3000 yen is very much welcome”.

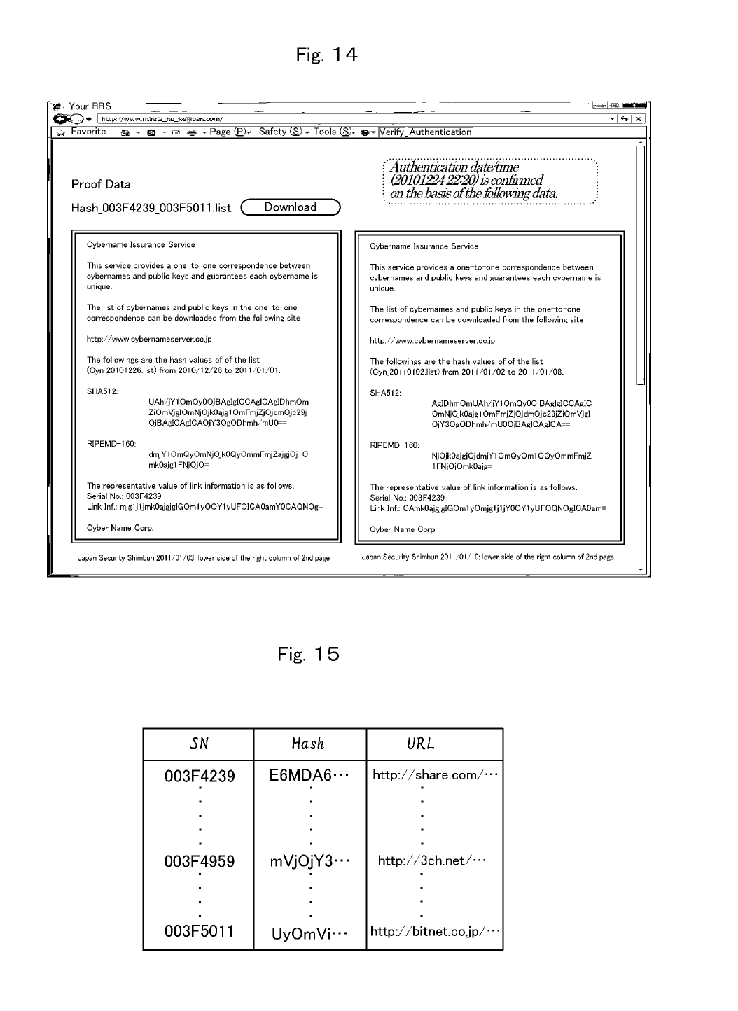

Furthermore, the screen shown in FIG. 14 is displayed by clicking an authentication date/time confirmation button shown in FIG. 13. This screen includes newspaper copies in which are published the representative values of the link information corresponding to the adjacent serial numbers between which the serial number “003F4959” is located. Namely, the adjacent serial numbers are the serial number “003F4239” which is the smallest among the serial numbers no larger than the serial number “003F4959” and the serial number “003F5011” which is the largest among the serial numbers no smaller than the serial number “003F4959”. Furthermore, there is a button for downloading a list file containing the proof data (hash values) therebetween.

This list file (Hash_{—}003F4239_{—}003F5011.list) contains table data as illustrated in FIG. 15. This table data is provided to associate each serial number with the hash value of the authenticated message and the URL of the posting site corresponding to the each serial number respectively. Accordingly, it is possible to calculate intermediate link information between the link information corresponding to the serial number “003F4239” and the link information corresponding to the serial number “003F5011”, and confirm the validity of the list file. Next, it is confirmed whether the hash value of the message matches the hash value of the serial number “003F4959” described in the list file. The authentication date/time can thereby be verified.

The verification of the aforementioned signature and the calculation and matching of the hash values are well known in the art and can be easily implemented by those skilled in the art. The utility software is implemented with such functions.

The personality of a user based on the past authenticated messages need not be the personality of the real person using the cybername. The real person can freely form a new personality corresponding to aZ38_Nuages in the cyber space called the Internet. The quality and quantity of the messages posted in the name of a cybername will determine the value of the cybername. Because of this, it is important to develop the name value of one cybername, but there is little to gain even if a person registers a number of cybernames. This feature is emphasized by rankings objectively obtained.

In this example shown in FIG. 12, the ranking is shown as 144/48237. This means that the cybername is 114th in 48237 cybernames. This ranking of 114 is stored in the ranking field of the cybername management table 61. This ranking is calculated on the basis of the number of points which will be explained below. Namely, the user has the 114th largest number of points.

Also, the user is rated on the basis of this ranking. For example, if the user is ranked within higher 5% of the cybernames, the rating is “AAA”; else if the user is ranked within higher 15% of the cybernames, the rating is “AA”; else if the user is ranked within higher 30% of the cybernames, the rating is “A”; otherwise the rating is “B”. This rating is included in the authenticated message, so that other users can know the rating of the message writer.

However, the value of the rating shown in the authenticated message posted to a BBS or the like is the value when posting the message. Accordingly, this value in the authenticated message may not match the value when another user reads the authenticated message.

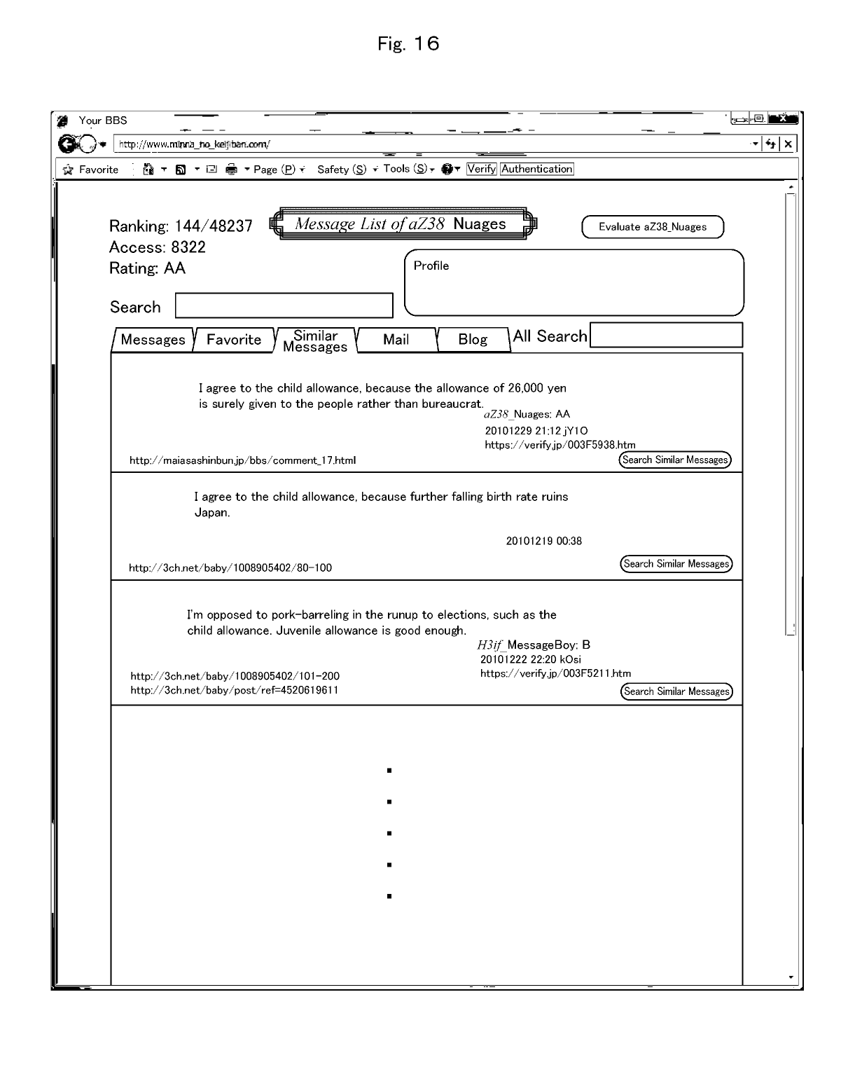

Additionally, each entry in the message list includes a button in the lower right corner thereof for displaying messages which contain similar content as the authenticated message. When this button is pressed, a screen shown in FIG. 16 is displayed. In this screen, the authenticated message is displayed in the upper most position, and the similar messages follow thereunder in the order of similarity while a higher priority is given to an older messages. It is therefore possible to use, as references, other opinions on the similar subject. The similar messages are displayed with different colors in order to indicate whether each message was posted before or after the date of the authenticated message. By this coloring, if the authenticated message contains significant originality, it is possible to know which user has first posted the content including the originality.

The similar messages may be displayed by the use of an existing search engine rather than displayed in the same window as the message list. In this case, search terms are extracted from the authenticated message by a morphological analysis or the like, and input to an existing search engine in order to obtain 5 to 10 search results by adjusting the number of input search terms. The search results are displayed in a page of the search engine.

<Verifying Authentication by Hash Value>

A browser may be implemented with the function of verifying authentication by implementing a plug-in or the like. In this case, the browser scans the text to be displayed, and detects the candidates of authenticated messages. The browser then acquires the hash value of each authenticated message by designating the serial number of the authenticated message. The authentication can be verified by comparing the acquired hash value and the hash value of the authenticated message of each candidate. The browser displays the indication that the message is correctly authenticated.

By this configuration, any user can confirm that a message is correctly authenticated only by opening a page which contains the message. Also, the message list can be displayed by clicking the link to the above URL containing the serial number of the authenticated message. In this case, if the above URL is not in the form of a link, the browser inserts an html tag for making the above URL a link.

Furthermore, in this case, the serial number of an authenticated message need not be contained in a URL. Only a serial number is described, and the browser makes the serial number a link. It is sometimes forbidden to describe a URL in a message. In such a case, an authenticated message provided only with a serial number is convenient.

<Points>

The number of points indicates the reliability of a user using the cybername. This embodiment makes it possible to evaluate a users with each other. Namely, each user evaluates the information posted by another. In order to effectively perform evaluation, however, several rules are posed. The following rules are example.

A user can evaluate a message of another user by giving evaluation points which may be minus points. For example, if some user repeats plagiarizing other's messages, a user can give minus points to the cybername of the some user. The evaluation points that a user can give are limited in accordance with the number of points the user has got. For example, if the ranking is “AAA”, the user can give 100 points a week; if the ranking is “AA”, the user can give 10 points a week; if the ranking is “A”, the user can give 5 points a week; and if the ranking is “B”, the user cannot give any points.

Just after starting the system, there is no user who can give evaluation points. Accordingly, the system gives evaluation points in accordance with the content of messages.

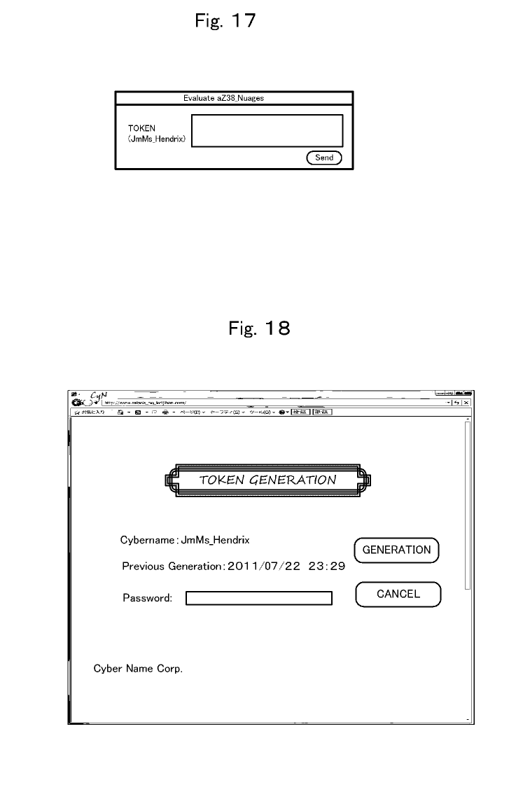

The user evaluation can be made, for example, through an interface which is implemented as a button captioned “Evaluate aZ38_Nuages” shown in FIG. 16. When this button is pressed, a dialog shown in FIG. 17 is displayed. This dialog includes an edit box in which can be input a token for confirming the evaluating user.

The utility software is then invoked to display a token generation window as shown in FIG. 18. The token used herein is a character string containing a cybername, the preimage of a confirmation hash, and a next confirmation hash which are separated by a separator such as a linefeed code. The confirmation hash is a numeric value stored in the cybername management table 61 shown in FIG. 6, and encoded to a character string by Base64.

When a generation button is pressed after inputting a password in the token generation window shown in FIG. 18, the utility software decodes the encrypted preimage of the confirmation hash by the use of the password. Also, the utility software generates a 256-bit random number as the preimage of a next confirmation hash. The next confirmation hash is calculated by processing this random number by SHA-2. The preimage of the next confirmation hash is encrypted with the password, and used to replace the encrypted preimage of the confirmation hash currently saved. However, the current encrypted preimage is temporarily stored. The password used herein can be the same as used to encrypt the private key.

The token can be obtained by concatenating the preimage of the current confirmation hash and the next confirmation hash to the end of the cybername with separators in a character string. This token is copied to a clipboard, and thereby can be pasted to the token generation window shown in FIG. 17. This token is transmitted to the management server as data attached to an evaluation feedback request.

When receiving the token, the management server confirms that the cybername has a right to evaluate, and that the confirmation hash stored in the cybername management table 61 matches the preimage of the confirmation hash of the token. If confirmed, the evaluation is reflected in the database. Furthermore, the management server overwrites the confirmation hash of the cybername of the user who has made the evaluation by the next confirmation hash contained in the token. In this case, the management server is required only to calculate the hash function one time only. However, in place of the token, the evaluation can be made by the use of text in a predetermined form which includes the evaluation of aZ38_Nuages and associated with a signature thereon.

Also, the benefits of affiliate marketing to be described below can be reflected in the evaluation of reliability. That is to say, if the user's page is accessed by many general users who then purchase goods, it is reasonable to increase the reliability thereof. Inappropriate evaluation can be effectively eliminated by connecting the evaluation with purchase.

<Copyright>

When a general user transmits information, there sometimes occur copy & paste problems. A user may review a highly-knowledgeable unique message of another user in a BBS, copies the message, and signs and posts the message to another BBS by pretending that the message is own opinion. Even in such a case, if the first user has signed the message, it is apparent who is the first user.

The reliability of the cybername of the user who has plagiarized is lowered. This is reflected in the points by allowing a user who dislikes such plagiarizing to reduce the points of the cybername in question by the above method.

Also in the case of original music, illustration, poems, or other creation rather than usual messages, plagiarism can be inhibited by authentication dates. For example, the authentication can be made after inserting the hash value of a music file or a video file to a message.

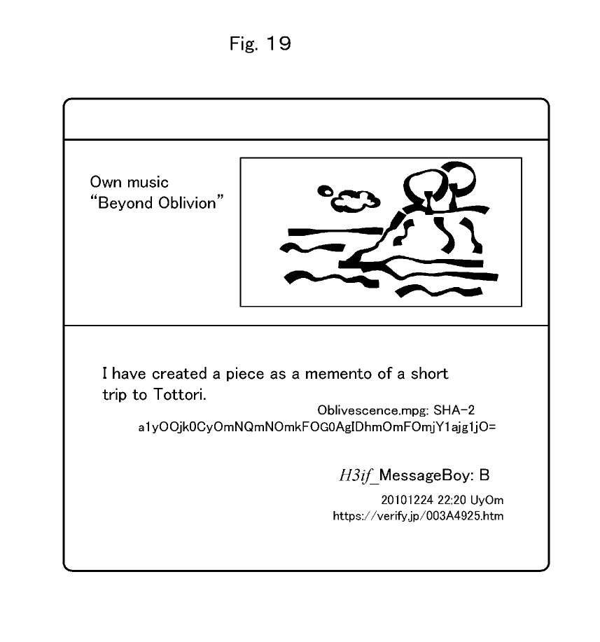

FIG. 19 shows an example in which an original music piece named “Beyond Oblivion” is associated with a motion picture and made public as an MPEG-4 file. In this case, the authentication of the cybername is made on the message that “I have created a piece as a memento of a short trip to Tottori” to which is added “Oblivescence.mpg: SHA-2 a1yOOj . . . 1jO=”. Of the message, “Oblivescence.mpg” is the file name of the video and processed by SHA-2 as a hash function and encoded by Base64 to generate the hash value “a1yOOj . . . 1jO=”.

For example, it is assumed that another user extracts music from the MPEG-4 file, slightly modifies the music and makes the modified music public as an own music piece. In this case, the authentication date/time of the message can furnish persuasive evidence that the modified music is a rip-off.

<Web Site Authentication>

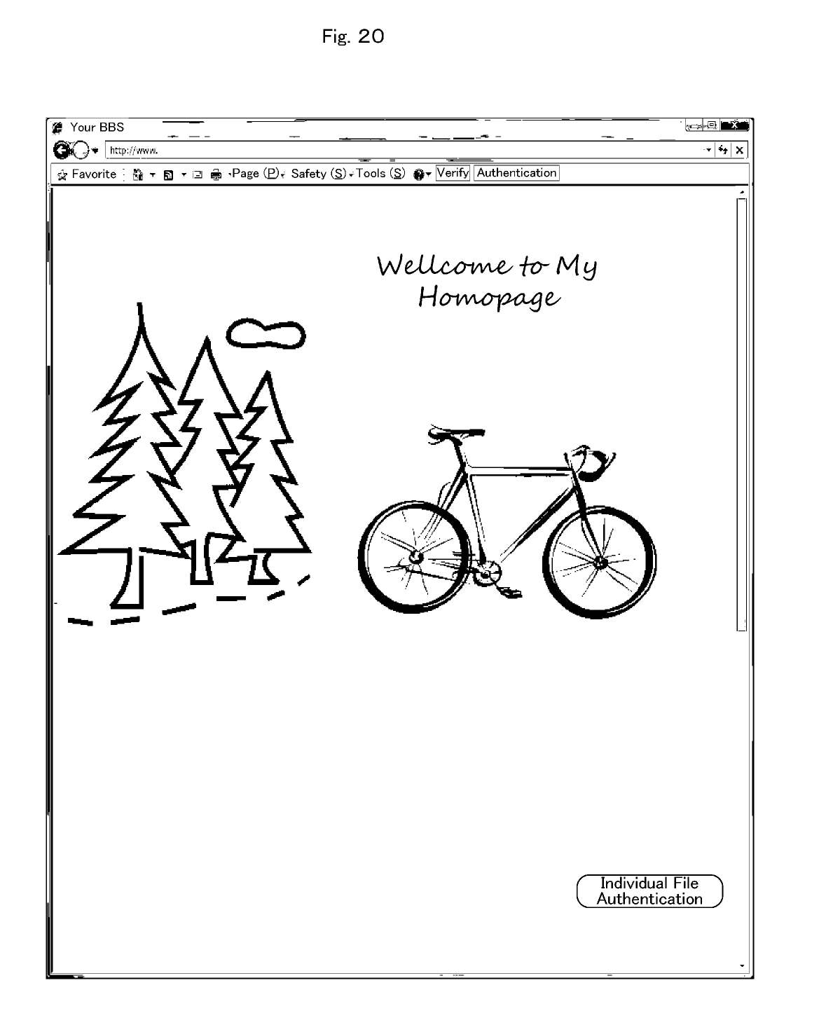

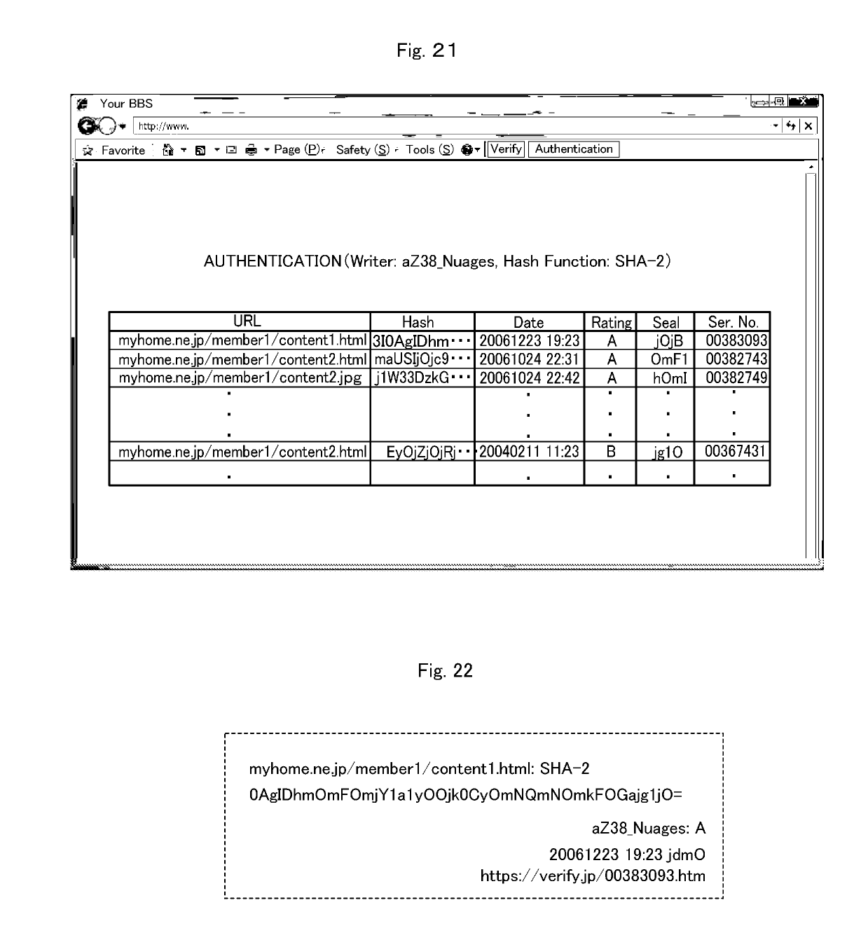

A Web site consists of a plurality of files. It is convenient to provide a separate page for confirming the authentication of such data. For example, the top page of the Web site includes a URL (link) to an authentication page as shown in FIG. 20. In this case, the link to the authentication page is implemented as a button which is captioned “individual file authentication”. This authentication page includes, for example, the content shown in FIG. 21.

Namely, this authentication page includes a list of URLs of data items (typically files) which are authenticated. The hash value of the data item indicated by each URL is authenticated as described above.

For example, the hash value of the file named “myhome.ne.jp/member1/content1.htm” is calculated, and encoded by Base64 into text data. This text data is given a user signature in the same manner as a usual message, and constructed in a predetermined format which is then transferred to the server for authentication. As shown in FIG. 21, this file is created at 20061223 19:23, and authenticated with the serial number 00383093.

In this case, the authenticated message corresponding to this file is constructed as follows. Namely, as shown in FIG. 22, the file name, the hash function, the hash value of the file, the cybername, the rating (Rating), the authentication date/time, the seal, and the URL including the serial number are joined in the predetermined format. As has been discussed above, the authentication can be confirmed with reference to the hash value of this authenticated message. The writer of the Web site can obtain the authentication by constructing the message to be authenticated in the predetermined format corresponding to the format shown in FIG. 22 from which the URL is removed, and requesting the server to authenticate the constructed message.

A Web page is often updated. In this case, the authentication may be repeatedly obtained on different authentication dates/times for the same URL. FIG. 21 includes two entries having different authentication dates/times for the same URL “myhome.ne.jp/member1/content2.htm”.

<Other Functions>

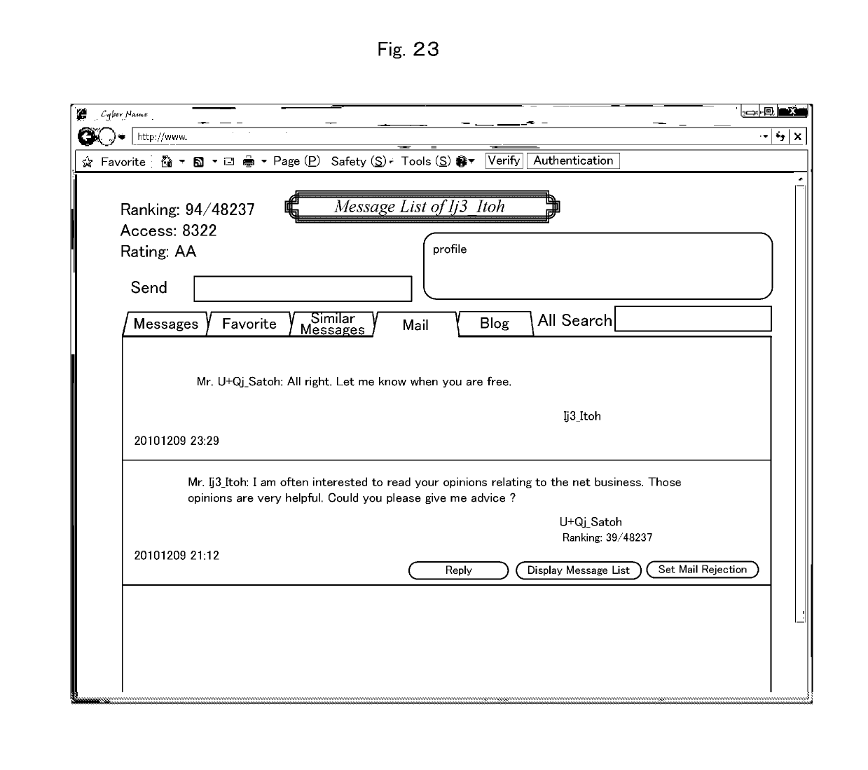

Some user may desire to send email directly to a user who looks reliable from the message list. For this purpose, the management server is implemented with a mailing function. This mailing function is provided through the window of the message list. For example, as illustrated in FIG. 23, the mailing function can be used by clicking a mail tab in the window of the message list.

Also, the management server may be implemented with a blog server function. This function can be used by clicking a blog tab in the window of the message list. This blog server function is effectively different than usual blog server functions in that the blog of a user is associated with other activities of the user with the cybername in the Internet.

The mail can be displayed after logging in the server with the cybername. The identity confirmation for logging-in can be performed by the confirmation hash. The transmission of mail can preferably be performed by attaching a signature for identity confirmation of the sender.

<Invalidation of Cybername>

Each user can invalidate his own cybername. This is done by transmitting an invalidation request to the management server together with a signature. The cybername and public key of the invalidated cybername are made public in the list whose hash value is published in a newspaper shown in FIG. 2. The reason for invalidating a cybername is, for example, leakage of the private key. FIG. 3 shows a list of invalidated cybernames below the list of registered cybernames. In this case, the expiration date (Expiration) of the cybername management table 61 is overwrites by the invalidation date/time. When a cybername becomes invalid, past valid messages can be read in the message list. However, it is notified that the cybername is invalid together with an invalidation reason and invalidation date/time.

An expiration date is set to each cybername. The expiration date is automatically updated if the cybername is rated “A” or higher. Updated expiration dates are published in a newspaper through the hash value in the same manner as the registration of new cybernames. However, the expiration date is not updated if the cybername is rated lower than “A” and a predetermined period has elapsed after last effective use. If the expiration date is updated, the expiration date (Expiration) of the cybername management table 61 is overwritten by the new expiration date.

<Quotation>

It is not good to use a message of another user in own message without saying the usage. On the other hand, the usefulness of the Internet is enhanced by spreading valid information. In this case, consideration can be given to the original writer by describing the quotation. The original writer can be identified only by describing the serial number of the original message. In addition to this, the cybername of the original writer can be described to further give consideration to the original writer.

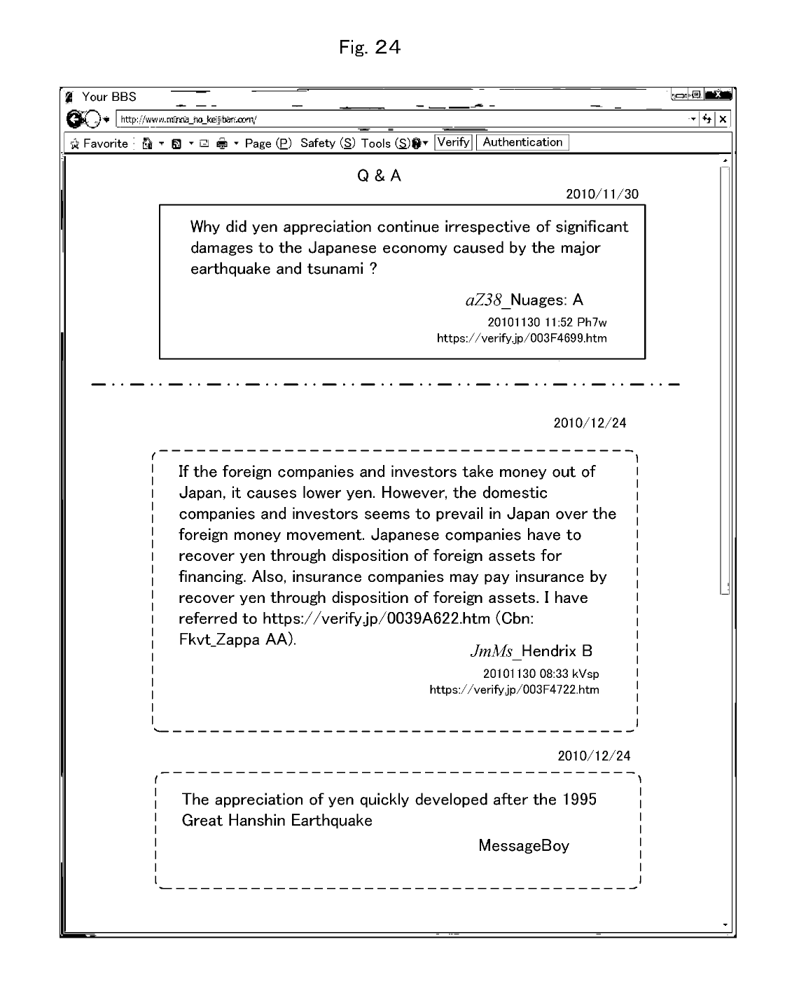

FIG. 24 shows an example. In this case, the original message is identified by the serial number after “sn:” and the cybername after “Cbn:”. If an authenticated message includes such a quotation, a link to the original message is provided for the serial number. Also, a link to the message list of the original writer is provided in the description of the cybername of the original message. A user can refer to the original message and the message list of the original writer by clicking these links. As has been discussed above, when messages in the name of a cybername are quoted followed by displaying the message list, points are added to the cybername.

<Earnings Model>

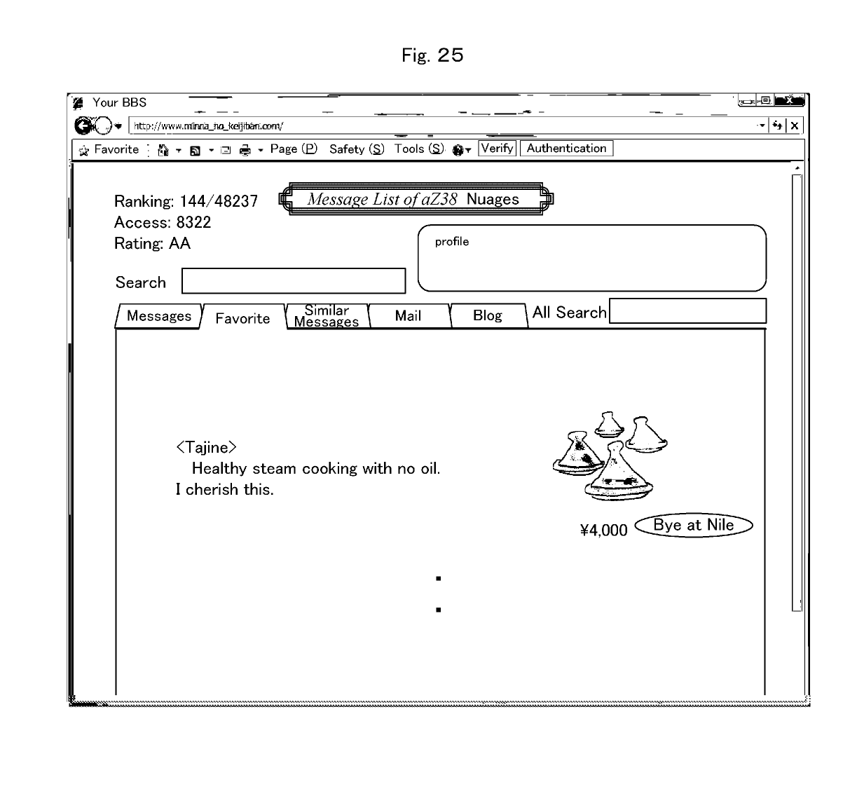

The message list shown in FIG. 12 includes a “favorite” tab. If the “favorite” tab is selected, a window shown in FIG. 25 is displayed. This message list can be used as a network medium on which an earnings model can be designed. That is, by selecting the favorite tab in the window, it is possible to know goods and services recommended by the user of the cybername. This favorite screen can be an effective advertising medium as long as the user is reliable. Also, an affiliate program can be used. The rewards are shared by the user and the system provider to cover the cost associated with the system maintenance.

<Others>

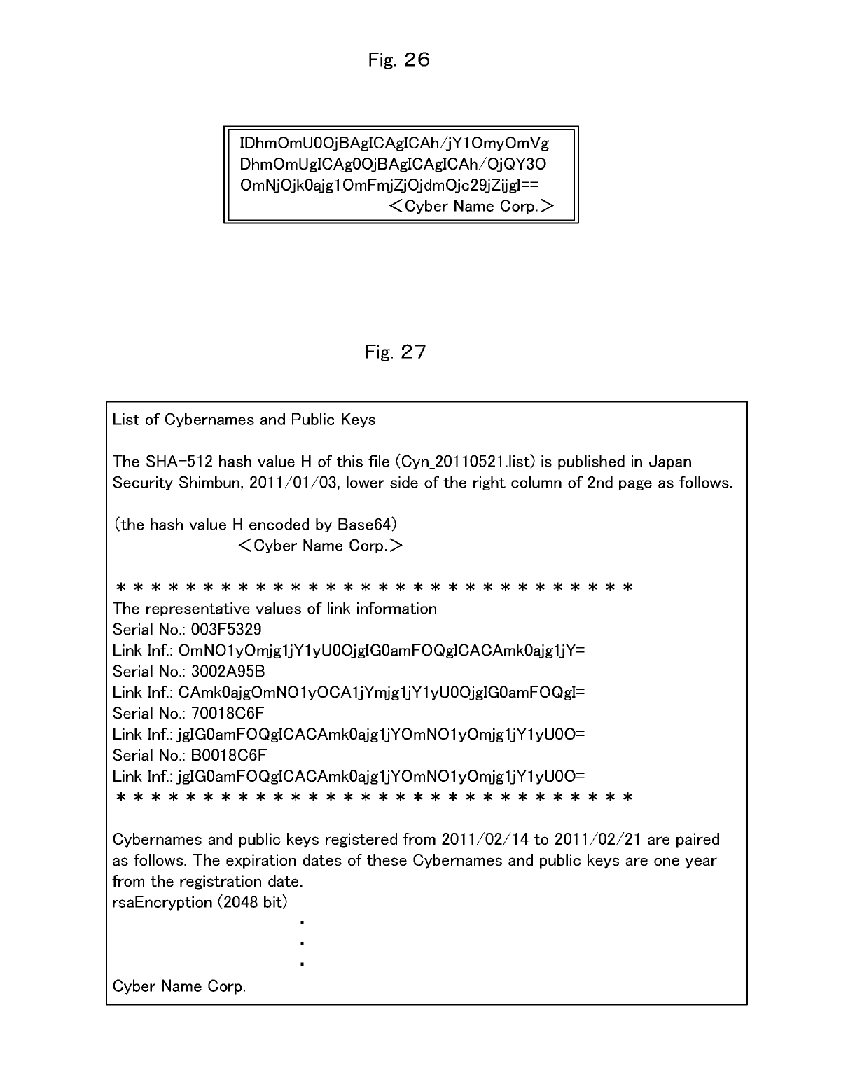

Pinning information by means of a publication can be performed only by publishing one hash value. Namely, in place of the newspaper publication shown in FIG. 2, a 512-bits hash value encoded by Base64 into 88 characters can be sufficiently used and effective as illustrated in FIG. 26 to which the name of the service provider is added. In this case, necessary information is fully described in the list file which is the preimage of the hash value. An example of the list file is shown in FIG. 27. The list file includes the newspaper publication and the representative values of link information.

In this case, a plurality of representative values of link information are described. The link information is described in the form of a plurality of chains. A message of a cybername is associated with one of the chains which is selected in accordance with the reliability of the cybername. For example, the reliability of the date authentication becomes high in the chain associated with reliable messages. On the other hand, the cybernames just after registration and the cybernames ranked at the bottom are associated with one chain. The multiple chains decreases the amount of proof data necessary for checking the link information even when messages enormously increases in number.

### Example 2

The identifier management system of this embodiment is implemented with the functionality of making it possible to change the public key in addition to the features of the embodiment 1. In the case of the embodiment 1, the authentication of a message is verified by the public key with reference to the registration date of the cybername thereof. The public key of the embodiment 2 can be changed so that different keys have to be used before and after the changing. Of course, a public key cannot be changed after the expiration date of the public key.

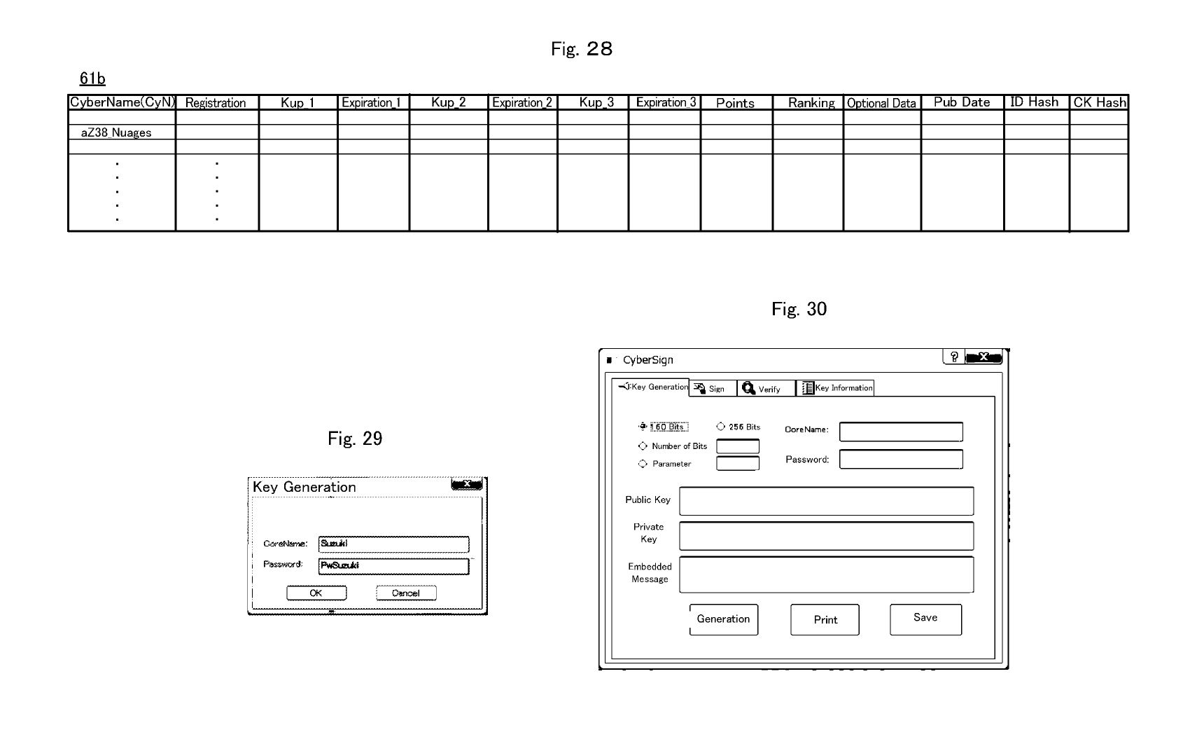

FIG. 28 shows a cybername management table 61b which is used in the embodiment 2. The registration date of a cybername is the registration date (Registration) of the public key (Kup_{—}1) of the cybername in the same manner as in the embodiment 1. The cybername management table 61b includes fields for a second user public key (Kup_{—}2) and a third user public key (Kup_{—}3) which are set to NULL when the cybername is registered. The expiration dates thereof (Expiration_{—}2, Expiration_{—}3) are also set to NULL.

The user public key of the cybername is changed by receiving a new public key from the user, and entering the new public key to the second user public key (Kup_{—}2) field. Also, the expiration date (Expiration_{—}1) of the user public key (Kup_{—}1) is overwritten with the changing date, and the expiration date (Expiration_{—}2) of the user public key (Kup_{—}2) is set to a predetermined date (for example, one year from the changing date). The public keys (Kup_{—}2) corresponding to the cybernames are published in a newspaper in the same manner as the registration and updating as described above.

The user public key can be further changed by receiving a further public key from the user and stored in the third user public key (Kup_{—}3) field. The expiration date (Expiration_{—}2) of the user public key (Kup_{—}2) is overwritten with the date of changing, and the expiration date (Expiration_{—}3) of the user public key (Kup_{—}3) is set to a predetermined date (for example, one year from the changing date). The public keys (Kup_{—}3) corresponding to the cybernames are published in a newspaper in the same manner as the registration and updating as described above.

While the public key can be changed up to two times in this example, the times of changing the public key can be further increased by adding fields of a user public key and an expiration date.

The authentication can be confirmed by displaying and checking the message list as shown in FIG. 11 in the same manner as in the embodiment 1. This means that the management server has confirmed the signature. The signature can be objectively verified at the user end by confirming which public key is used for verifying the message with reference to the registration date (Registration) and the expiration date (Expiration_{—}1, Expiration_{—}2). For example, if the date of the message is between the expiration date (Expiration_{—}1) and the expiration date (Expiration_{—}2), the user public key (Kup_{—}2) can be used.

Next, the user public key (Kup_{—}2) is verified from the corresponding list file on the basis of the published data of the newspaper. Finally, the signature of the message can be verified with the user public key (Kup_{—}2).

The reason for changing the user public key is, for example, leakage of the private key. It is desirable to immediately change the public key when there is suspicion of key leakage. The identity confirmation with a private key is inappropriate, so that another mechanism is implemented in this embodiment.

The cybername management table 61b includes a key change hash (CK Hash) field. When a new cybername is registered, the user recursively processes a random number a predetermined times (two times in this case), and sends the result to the management server for registering the result as a key change hash. This random number is used only when changing the public key, and therefore safely stored, for example, by printing on a sheet.

The user has to attach the preimage of a key change hash (CK Hash) to the request of changing the user public key to the public key (Kup_{—}2). The management server processes the preimage by the hash function, and changes the public key to the public key (Kup_{—}2) if the hash value of the preimage matches the key change hash. When the user wants to change the user public key to the public key (Kup_{—}3), the preimage of the preimage of the key change (i.e., the first random number) hash has to be attached to the request of changing the user public key in the same manner as the first request of changing the user public key. The management server processes the preimage twice by the hash function, and changes the public key to the public key (Kup_{—}3) only when the result matches the key change hash.

### Example 3

While the server is indispensable for managing public keys and signatures in the case of the above embodiments, it is possible to add a signature directly to a message. In this case, it is possible to implement the system only with a local signature verification program. The signature verification program of this example is implemented with the following functions.

A private key is indispensable for signing a message. Accordingly, a key generation function is implemented. The key generation function serves to generate a pair of a private key and a public key. Also, a signature generation function is implemented to generate a signature by the use of a private key. Furthermore, a signature verification function is indispensable for verifying a signature attached to a message. Still further, the signature verification program serves to manage private and public keys. Still further, the signature verification program serves to acquire a public key from a networks or the like.

<Operational Procedure>

In what follows, the general outline of the usage and interface of the signature verification program will be explained in accordance with operational steps which the user has to take. The details of these steps will be explained in detail later. In this case, the signature verification program uses ECDSA which is one of the elliptic curve cryptosystems. Also, a cybername consists of a core name which can be arbitrarily selected by the user, a dollar mark “$” attached to the top of the core name, and a suffix in the form of “_***” attached to the end of the core name where “*” is a base64 character.

When invoked, the signature verification program confirms whether or not there is a personal key file (to be described below) in a hard disk. The personal key file contains a private key which is encrypted. One of simple methods is to access a particular file name of the holder in which the signature verification program is located. The personal key file does not exist when the signature verification program is invoked for the first time. If no personal key file exists, a dialog is displayed as shown in FIG. 29. Even if there is a file named as the personal key file but no private key is contained therein, it is determined that no personal key file exists.

The key generation through this dialog is performed by the ECDSA algorithm in which the parameter set is fixed to secp160r1 based on the SECG standard. While the key length of secp160r1 is 160 bits, a longer key can be generated by another dialog as an advanced settings screen (refer to FIG. 30). Incidentally, in the case of ECDSA, there are a plurality of different parameter sets having the same key length. These parameter sets are distinguished by giving different names for different elliptic curves. However, in this example, different numbers nID's are used to identify an elliptic curve.

The dialog as shown in FIG. 29 includes an edit box for entering a core name and an edit box for entering a password. The user decides a desired name (character string), and enters it in the core name edit box. Also, the user decides a password, and enters the password in the password edit box.

The user then clicks an OK button. The signature verification program then generate a private key and a public key, and adds a suffix “_qv2” to the end of the core name. Furthermore, “$” is added to the top of the core name to construct a cyber name ($Suzuki_qv2) which is the identifier corresponding to the public key. The string “qv2” is determined by base64 encoding the public key and extracting the 3rd to 4th characters from the encoded public key. The aim of the character “$” and the suffix will be described later.

The signature verification program then searches the Internet to determines whether or not the same cybername is used. Actually, the signature verification program searches the Internet for the cybername by the use of a search engine and determines that the cybername is not used if there is no hit. The practical procedure will be described later.

If there is a hit, the same cybername may have already been used, and therefore other private and public keys are generated to change the suffix. The suffix is changed until there is no hit by the string search. In fact, since the suffix is substantially a random number of 3 characters, there is little possibility that there is a hit for the string “$(user selected core name)_***”. When the suffix is changed, the user is notified of this change.

The format of the cybername increases the possibility of generating a unique cybername by using the special character and a random characters between which is located a core name which is arbitrarily selected by a user. The special character is a character other than phonogramic and ideographic character such as Kana or Kanji.

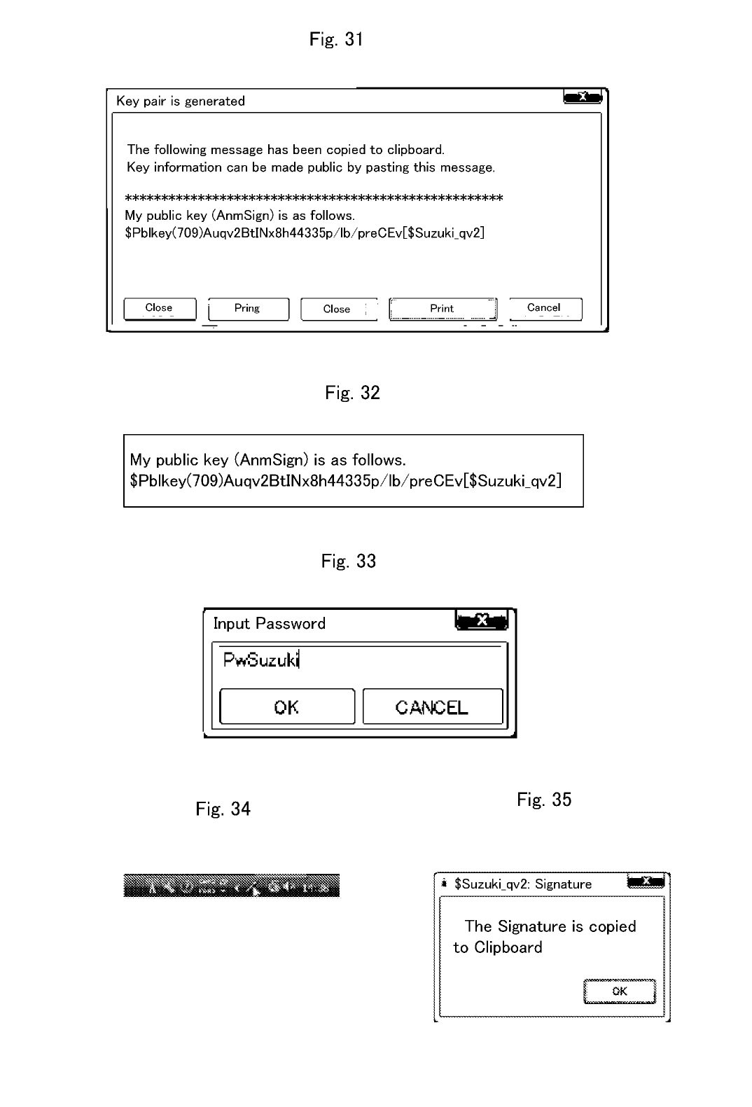

The signature verification program then copies, to a clipboard, a message which is prepared for making public the public key in the Internet, followed by displaying a dialog shown in FIG. 31. This message includes a character string consisting of a keyword “$Pblkey” indicative that public key information is laid open by this message, the number nID in round bracket indicative of an elliptic curve parameter set, a public key encoded by base64, and a cybername in square brackets arranged in this order.

In FIG. 31, the public key information is from the keyword “$Pblkey” to the cybername. The user makes public this public key information at an arbitrary site on the Internet (refer to FIG. 32). The arbitrary site may be SNS, BBS, blog or the like. However, if the site may be closed, the above procedure may be performed again. On the other hand, the generated private and public keys are locally stored in association with the number nID and the cybername. However, the private key is encrypted with a password, and stored in a file named a predetermined file name in the same folder as the signature verification program in the hard disk. This is the personal key file as described above.

The procedure to be taken by the user for generating a signature is as follows. The private key for generating a signature is encrypted and stored in the personal key file. Just after key generation, the signature verification program saves the private key as plain data in a memory.

If an encrypted private key is stored in the hard disk when the signature verification program is invoked, a dialog is displayed to prompt the user to enter a password as illustrated in FIG. 33. The signature verification program decrypts the private key with the input password and maintain the private key as plain data in the memory while the signature verification program is running, so that signatures can be generated with the private key in the memory. If no password is entered to this dialog to cancel, the password is required each time the user generates a signature.

The user prepares a message on which the user wants to generate a signature. For example, the user may input a message “Child allowance increment of 2-3000 yen is very much welcome” in an edit box of a web page. The user copies the message to the clipboard followed by clicking an icon displayed in the screen. In this example, the icon is an pen-like icon of the signature verification program displayed in the task tray (FIG. 34).

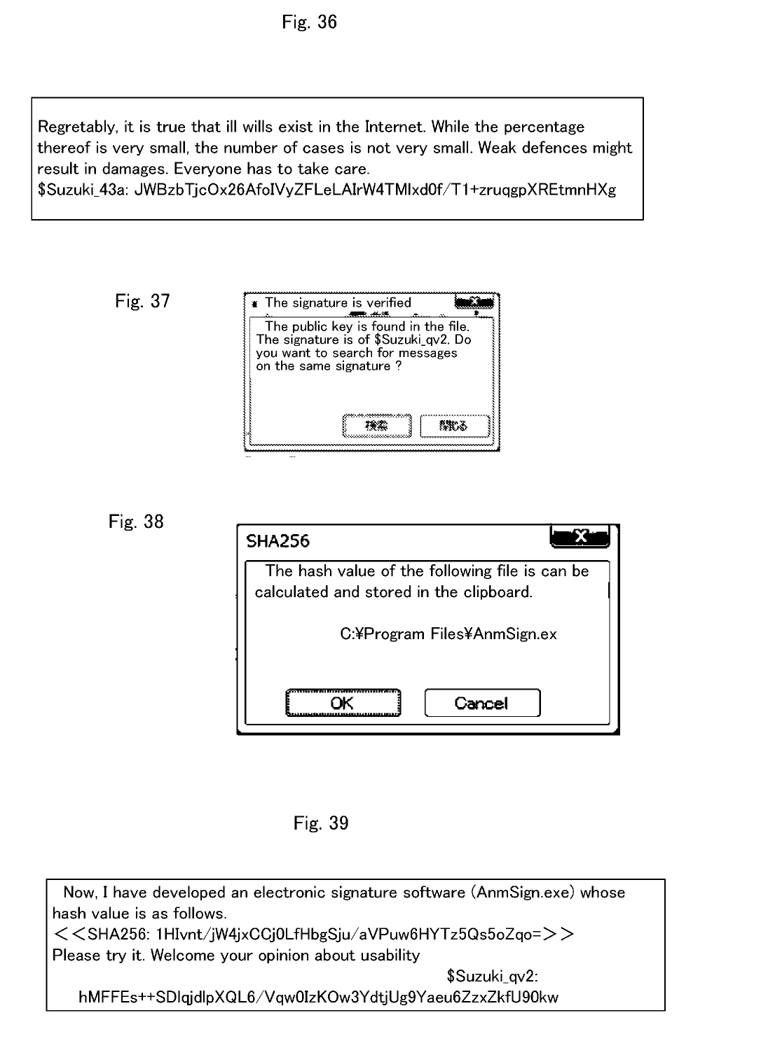

When receiving a click event, the signature verification program confirms data in the clipboard, and generates a signature on a message if the data is a message which has not been signed yet. The generated signature is copied to the clipboard together with the cybername (FIG. 35). The user can paste the content of the clipboard to the end of the message to form the signed message. This signed message can be used, for example, in a box shown in FIG. 36.

In this signed message, the cybername and the signature are separated by a colon. When the user clicks the icon displayed in the screen, if the clipboard contains a message accompanied with a signature, the signature verification program verifies the signature, rather than generates a new signature, and display the verification result. Specifically speaking, if the clipboard contains a character string including a cybername+a colon+(base64 string having a predetermined length) at the end, the signature verification program recognizes a signed message.

Accordingly, when the user is browsing a signed message in a web page and wants to confirm (verify the signature of) the message writer, he copies the signed message to the clipboard and click the icon displayed in the screen. Then, the result of verification is displayed. If the verification succeeded, the information posted by the same person (signature) can be found by clicking a search button (FIG. 37). Incidentally, it will be explained later how to obtain a public key which is necessary for verification.

<Key Generation>

A private key of ECDSA can be a random number smaller than a certain number. In the case of the above example, the key length is 160 bits, and the private key is a number of 20 bytes. On the other hand, the public key is a point of an elliptic curve and represented by a number of 40 bytes. Since a compressed representation is used in this example, the public key is represented by 21 bytes. The private key is BASE64 converted to 27 characters, and the public key is BASE64 converted to 28 characters. In accordance with usual BASE64 conversion, the number of characters is a multiple of 4 so that the private key is converted to 28 characters with a padding of ‘=’. On the other hand, a signature is represented by a pair of numbers having the key length, i.e., a number of 40 bytes. Accordingly, a signature is converted to 56 characters with a padding of ‘==’. However, in this example, the redundant padding is omitted to shorten the length of a signature. The signature length is thereby 54 characters.

The signature verification program adds the BASE64 character string directly to the message as information transmission. The public key is generated as a BASE64 character string, made public and stored as it is. This is simple string information and can be directly and visually understood. The private key is also simple string information which, however, is stored in an encrypted string.

<Signing>

The signing algorithm is as follows. First, a message to be signed is acquired. The signature verification program acquires a message through the clipboard. Next, a cybername terminated with a colon is added to the end of the message. Space characters (including one-byte space, two-byte space, return character, tab) are removed from the message having the cybername. Next, the character codes of this message are converted to unicodes. The character encoding scheme to be used is UTF-8. The character string thus obtained is then processed by SHA256.

An digest of the key length is extracted from the hash value of the character string, and processed by ECDSA to calculate a signature. The ECDSA signing process is performed by the use of the private key (and the number nID). The ECDSA signing process uses a random number which is generated anew each time this signing process is performed for a security reason. Because of this, even with the same digest, a different signature value is generated every time. Finally, the signature is encoded by BASE64 to obtain a character string corresponding to the signature. The signature in the form of a character string is added to the end of the cybername with an intervening colon to generate a signed message as a whole.

Space characters are removed for the purpose of avoiding the failure of verifying the signature associated with a substantially same message. In the case of an English message, all the words are connected to each other before signing. However, since space characters are removed just before calculating the hash value, a new line character or the like can be inserted between a cybername and the message body. The unicode conversion is performed for the purpose of avoiding influence of the character encoding system on the signature. If a message consists of a character string encoded by unicode (UTF-8), no conversion is needed.

<Verification>

The verifying algorithm is the reverse of the signing algorithm. First, a message to be verified is acquired. Next, a BASE64 character string is extracted from the tail of the message. In other words, the first character of a signature is identified by searching the character string from the end for any character other than BASE64. However, space characters (including one-byte space, two-byte space, return character and tab) which may be inserted for the purpose of reshaping the format of the signed message are skipped. It is determined whether space characters are inserted for the purpose of reshaping on the basis of the number of return characters and so forth. In this case, the signature corresponds to the character just after the colon from the end. If the length of the character string is out of the range of the signature sizes.

Next, a cybername is extracted from the tail of the message from which the signature is extracted. First, the message is searched from the end for a character other than space characters and a colon to specify the end of the cybername. Next, the top of the cybername is specified by searching the character string from the end of the cybername for a delimiter between the cybername and the message body. The delimiter is a dollar mark “$” in the case of the above cybername format. Furthermore, it is checked if there are appropriate character strings before and after the underbar in the cybername. If a correct cybername cannot be confirmed, the signature verification program determines that the character string is not a signed message. A signature can be accurately identified by this process.

Next, the public key (including the number nID) corresponding to the cybername is acquired. This procedure will be described latter. If the public key cannot be acquired, the signature verification program notifies this fact and finishes the process. However, a user may get the public key by searching the web, directly receiving from the owner of the cybername or any other procedure.

The verification of a signature becomes possible after extracting the signature, specifying the cybername, and acquiring the public key (including the number nID) as has been discussed above. First, space characters (including one-byte space, two-byte space, return character and tab) are removed from the character string including a message body, a cybername and a colon, i.e., the character string terminating in a colon. Next, the character codes are converted to unicodes. The character encoding scheme to be used is UTF-8. The character string thus obtained is then processed by SHA256. A digest of the character string is obtained from the hash value of the character string corresponding to the key length.

Finally, it is confirmed that this digest is the same as calculated when signing by the known algorithm of ECDSA. The ECDSA verifying process is performed by the use of the public key (and the number nID). If it is confirmed, the verification succeeds. If not, the verification fails.

<Public Key Acquisition>

As has been discussed above, the public key information output by the signature verification program is a character string consisting of the keyword “$Pblkey” indicative that public key information is laid open by this message, a number nID in round bracket indicative of an elliptic curve parameter set, a public key encoded by base64, and a cybername in square brackets arranged in this order. When receiving a sequence of search terms between “s (straight quotation marks), many search engines output only web pages containing the search terms connected in this order. For example, in response to the search request with “$Pblkey”, the hit page shall includes “$Pblkey” rather than “Pblkey”. It is possible to effectively find out the public key information by the use of this keyword as part of search terms.

Next, the format of cybernames is important. Also in this case, a cybername is placed between “s as a search term to avoid interference with other character strings. First, “***” of the string “$(user selected core name)_***” is automatically determined by extracting characters of the base64 encoded public key in predetermined positions. For example, if the public key is “AmohjFfOA7RwSPFoQR/bOsjDMNcD”, and the predetermined positions are 3rd to 5th positions, the suffix is “_ohj”. Any other positions can be used for this purpose. However, it is preferred not to use the beginning characters of a compressed ECDSA public key which are not even.

If the three characters are random numbers, there are 262,144 combinations. Exactly speaking, the three characters are not random numbers. However, taking the subsequent arbitrary character string into consideration, it is very rare to generate the same cybername by chance. Anyway, when generating a cybername, the signature verification program checks if the cybername is unique in the Internet so that the cybername shall be always unique. Also in this case, a cybername is placed between “s as a search term to guarantee the uniqueness.

Nevertheless, if two user use the same cybername, it is unlikely to be a coincidence but likely to be spoofing. If someone simply uses the same cybername, it is easy to determine cybername spoofing with the associated public key which cannot agree with the cybername. The signature verification program checks the consistency between the public key and the suffix. If they are inconsistent, the public key is likely to be generated for a malicious purpose.

A little knowledge of this technical field makes it possible to generate a public key which is consistent with a given cybername, although it takes a substantial length of time. However, in the case of signature spoofing, the original public key cannot be used for verification, so that there is little benefit of spoofing.

When verifying a signed message, the signature verification program performs AND search with a first search term which is prepared by placing the cybername placed between “s and a second search term “$Pblkey” to obtain the public key. If the public key is laid open in the Internet, it will be uniquely hit.

<Signing Files>

A file can be signed as follows. First, an explanatory note of the file may be prepared. The explanatory note is, for example, such that “I have developed an electronic signature software whose hash value is as follows. Please try it.” The hash value of the file is base64 encoded and inserted to the explanatory note, followed by signing the explanatory note as has been discussed above. In this example, the hash function is SHA256.

The character string of the hash value can be calculated by the following steps. First, the link to the file is copied. In the case of Windows (registered trademark), the link can be copied by selecting and copying the file in File Explorer. Next, the character string of the hash value is stored in the clipboard by clicking the icon displayed in the screen (FIG. 38), and pasted in the explanatory note. In this example, the character string of the hash value is concatenated after a keyword “SHA256:” in the clipboard. For example, the explanatory note is for example as described in FIG. 39.

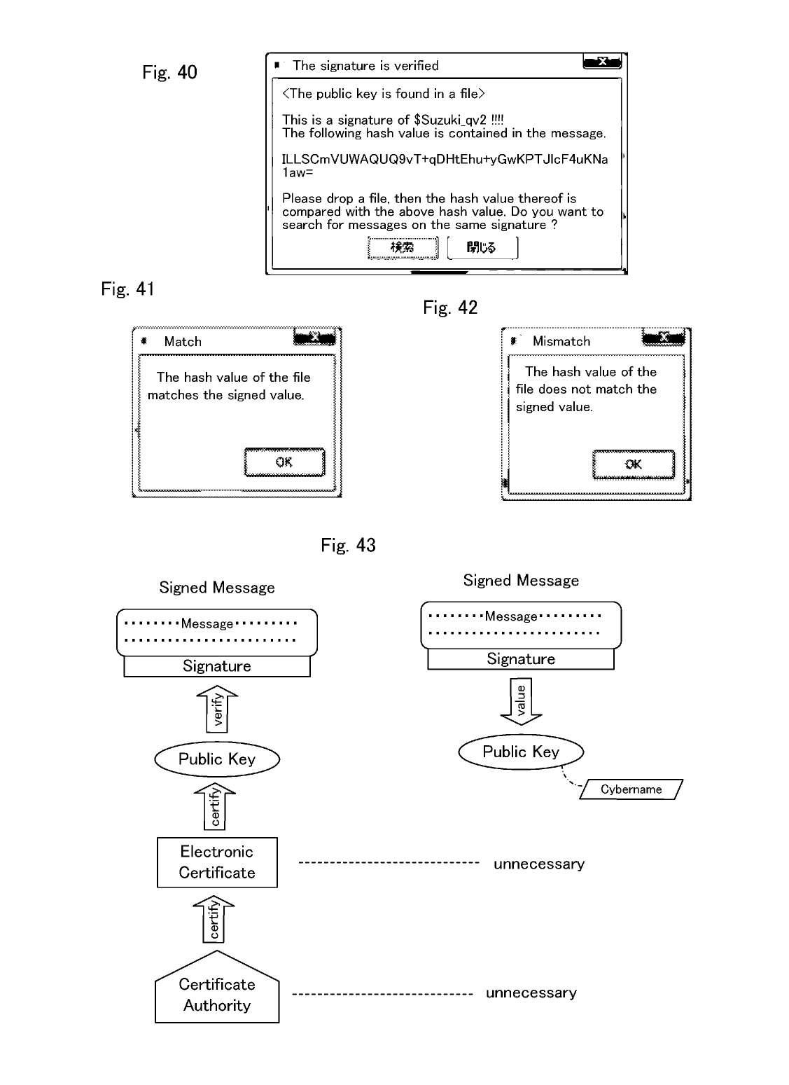

Such a message can be verified as follows. The entirety of the message is copied together with the signature as has been discussed above. Then, when the icon displayed in the screen is clicked, the signature verification program verifies the signature and display the result. If the message includes the keyword “SHA256:” followed by the character string of the hash value, the screen is as shown in FIG. 40.

This screen is ready for accepting file selection from the user. In this example, the user can select a file by drag and drop. The signature verification program calculates the hash value of the dropped file and compares this hash value with the hash value contained in the message. A dialog is then opened as illustrated in FIG. 41 or 42 in accordance with whether they are coincident or not to notify the user whether the file is verified or not.

Accordingly, when the icon is clicked, the signature verification program parces the content of the clipboard. If the content is the link to a file, the signature verification program calculates the character string of the hash value of the file with the keyword, and stores it in the clipboard, followed by notifying the user of this process. If the content is text accompanied by a signature, the signature verification program verifies the signature and display the result. In this case, if the authenticated message includes the character string of the hash value of a file, the file is verified as described above. If the content is text without a signature, the signature verification program generates and stores a signature in the clipboard, by notifying the user of this process.

<Effects of Signature>

Since no electronic certificate is associated with the public key corresponding to a signature in accordance with this example, the signature cannot guarantee any relationship. The signatures having an equivalence relation complement each other by the content of each message. For example, the cybername repeatedly transmitting valuable information and attractive content is considered to be trusted. If such a cybername is used to transmit new information, the signature of the cybername can be one of the criteria for estimating the reliability of the information. Conversely, it can be said that the name value of the cybername is high in terms of the influence of message transmission in the Internet.

The signature verification program provides the search button in the verification result displaying dialog (FIG. 37) for the purpose of evaluating the reliability of the cybername. The web pages are searched for the cybername by pressing this button. Since the cybername is unique as described above, the search results include the information transmitted by the same cybername. The search results can be references for evaluating the reliability of the signed message.

However, since there may be signature spoofing, the signature verification program verifies each signature appearing in the search results, and distinguishes the information associated with an invalid signature by the use of different views (by displaying such information with a red font in this example). It is possible to delete all the information on which verification failed from the list of the search results. However, the base public key itself would have related to spoofing, and therefore the view of information is simply differentiated.

This relationship between the public key and the signature is reverse as compared with the conventional relationship. That is, in accordance with the conventional systems, the origin of a message is indicated by a signature, the origin of which can be verified by a public key, the origin of which is certified by an electronic certificate, the origin of which is certified by a certificate authority. It requires much cost and troublesome procedure to have a certificate authority issue an electronic certificate.

Contrary to this, in accordance with the present invention, every user can simply sign a message without any requirement. The content of a message increases the value of the signature, which increases the value of the public key. This relationship is shown in FIG. 43. If the quality of the message is low, the value of the public key decreases. Accordingly, it is expected that high quality messages increases.

### Example 4

The personal key file of the embodiment 3 is encrypted but stored in a local PC. Accordingly, if the local PC is infected by a malware, the personal key file can be leaked outside. In such a case, the password protection may not be sufficient so that the private key can be known by brute force or dictionary attacks. In accordance with this embodiment 4, the above risk is avoided by the use of another network connection for generating a signature. This embodiment 4 shares similar processes with the above embodiment 3 except for generation of signatures. In what follows, the features of the embodiment 4 differing from the embodiment 3 will be mainly explained.

In this case, a mediating server is provided. This mediating server serves to save data such as a message in association with an identification number. When receiving a registration request with data, the mediating server temporarily registers the received data and returns an identification number. Also, when receiving an inquiry request with an identification number, the mediating server temporarily returns the data corresponding to the identification number. Furthermore, when receiving an updating request with an identification number and new data the mediating server updates the data corresponding to the identification number with the new data.

Meanwhile, the mediating server uses a database which is a simple ring buffer which is rewritten from older data. Accordingly, each data item is deleted by overwriting in a several minutes. Such a short-term memory is desirable not only in terms of speeds but also in view of security. The identification number is a six digit number in this example.

The process of signing in this example is performed in cooperation with a mobile terminal. Accordingly, a cooperative application is installed in the mobile terminal. It is assumed that a user wants to generate a signature with a PC and this mobile terminal. The cooperative application has the functions of reading two-dimensional codes such as QR codes (registered trademark), performing communication with the mediating server, and generating a signature on a hash value.

The key generation is the same as in the embodiment 3. After generating keys, only the cybername, the number nID and the public key are stored in the PC. On the other hand, the private key is displayed in the screen as a two-dimensional code together with the number nID. The user reads this two-dimensional code with the mobile terminal which then saves the private key and the number nID. The private key is not saved at the PC end.

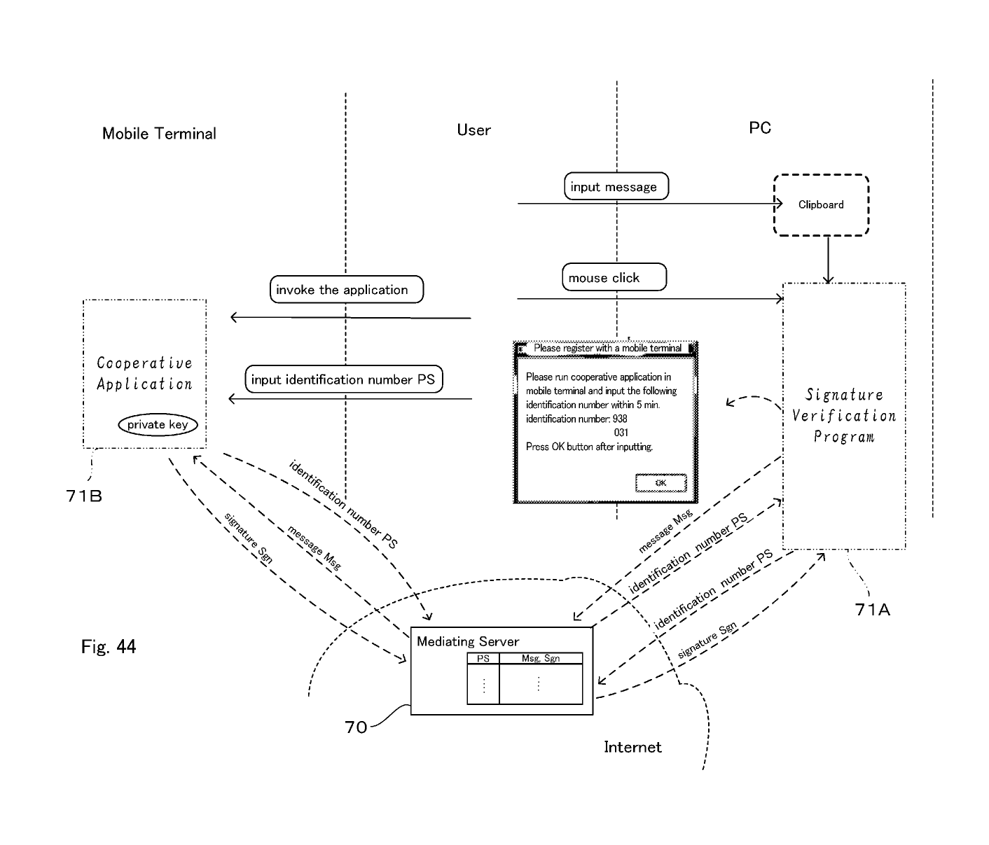

The process of signing in accordance with the embodiment 4 will be explained with reference to FIG. 44. The user stores a message in the clipboard followed by clicking the icon. The signature verification program 71A adds a cybername to the message and calculates the hash value (SHA256) thereof. These steps are the same as those of the embodiment 3. In the case of the embodiment 3, a signature on the hash value of the message is generated in the local PC. However, in the case of this embodiment 4, the signature is generated at the mobile terminal end as explained below.

First, the signature verification program 71A requests the mediating server 70 to register the message. The message consists of the message body, the cybername and a colon as described above. In response to the registration request, the mediating server returns a six digit the identification number. The identification number is generated as a random number and therefore serves as a security code. The signature verification program 71A displays this identification number in a dialog. The user then invokes the cooperative application 71B in the mobile terminal and enters this identification number.

Then the cooperative application 71B transmits a data inquiry to the mediating server together with this identification number. The mediating server returns the message corresponding to the identification number. The cooperative application 71B displays the received message. The user confirms the message and presses an OK button. The cooperative application 71B calculates the signature on the hash value thereof, and transmits the signature as update data together with the identification number. The mediating server updates the data corresponding to the identification number by the received data.

Thereafter the user closes the dialog in the PC, and the signature verification program 71A transmits an inquiry request to the mediating server with the identification number. The signature verification program 71A then receives the signature as the update data. If the registered message is returned, the data has not been updated yet so that the user has to inquire again after a while.

By this configuration, even if the PC is infected by a mulware, the personal key file does not contain the private key, which thereby shall not be leaked from the PC. Also, even if a trojan monitors or controls the communication of the PC, the private key cannot be get. The signing process requires operation at the mobile terminal end, so that no fraudulent signature can be generated.

### Example 5

Generally speaking, there is very few mulwares infecting the cellular phone. However, in recent years, security is becoming big problems particularly in the field of smartphones. If the private key is leaked from a mobile terminal, it is easy to calculate the public key. There is the possibility that the cybername is also known in association with the known public key. The embodiment 5 is directed to the measure of preventing private keys from being leaked from mobile terminals.

In consideration for user-friendliness, the private key of the embodiment 4 is not encrypted. Even if a private key is encrypted with a password, once the encrypted private key is leaked, there is a good possibility that the private key is decoded for example through dictionary attacks since the password is a character string which is not hard to remember for a user. The embodiment 6 encrypts the private key with a random number having a sufficient length (for example, the same length as the private key) in place of a password. In what follows, the features of the embodiment 5 differing from the embodiment 4 will be mainly explained.

First, when generating a key pair, the PC also generates a random number having a sufficient length (for example, 256 bits). This random number and the private key are exclusive ORed to calculate an encrypted private key. This encrypted private key is stored in the mobile terminal via a two-dimensional code. On the other hand, the PC stores the public key and the random number. Each time a signature is generated by the mobile terminal, the message to be signed is transmitted together with the random number from the PC through the mediating server. Accordingly, the mobile terminal can decrypts the private key by exclusive ORing the encrypted private key and the random number, and generate a signature on the message.

In this case, even if the public key and the random number are leaked from the PC, it is impossible to calculate the private key therefrom. On the other hand, since the encrypted private key appears a meaningless random number, there is no problem if any information is leaked from the mobile terminal.

### Example 6

The following option is additionally implemented in the signature verification program 71A in the case of the embodiment 6. Namely, when a message is not so long, for example, within 256 bytes, the entire text of the message is displayed in the form of a two-dimensional code on the PC. The cooperative application 72B in the mobile terminal reads the two-dimensional code and calculate the hash value and a signature.

The cooperative application registers the hash value and the signature in the mediating server. The hash value is used as an identification number in association with which the signature is registered. The PC can acquire the signature by calculating the hash value and inquiring of the mediating server with the hash value as the identification number for the signature.

### Example 7

In the case of the embodiments 4, 5 and 6, since the mobile terminal acquires a message, a user can confirm the message in advance of signing the message. It is however possible to acquire only a hash value to be signed in place of the message itself, and generate a signature on the message unread. In this case, the following steps are taken.

First, the two-dimensional code of a hash value is displayed on the screen of the PC. Next, at the mobile terminal end, the cooperative application reads this two-dimensional code and calculates a signature on the hash value. The cooperative application then registers the hash value and the signature in the mediating server. The hash value is used as an identification number in association with which the signature is registered. The PC can acquire the signature by inquiring of the mediating server with the hash value as the identification number for the signature.

### Example 8

The procedure shown in the embodiment 4 can be applied to the authentication in a site, where a user has registered, by making use of the mobile terminal as a security token. For example, conventionally in many cases such as online banking, the log-in process is performed by the use of a user ID and a password. In addition to this, the mobile terminal in front of the user can be used to improve security as follows. Of course, this method can be applied to general log-in processes other than online banking.

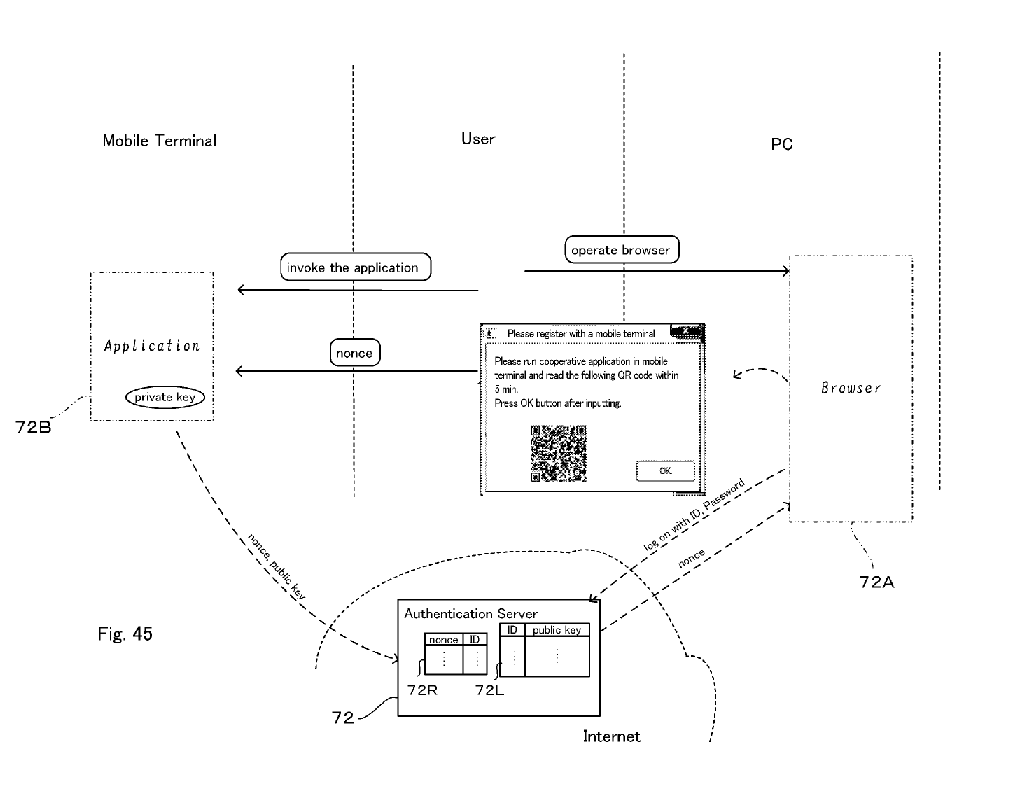

An dedicated application is installed in the mobile terminal in advance. With reference to FIG. 45, first, the browser 72A of the PC accesses an authentication server 72, and performs a log-in process by the use of a user ID and a password. The user then opens a page for registering public keys.

The authentication server 72 transmits a 128 bit random number (nonce) to the browser 72A for authentication. On the other hand, the authentication server 72 saves this random number in a ring buffer 72R in association with the user ID. The browser 72A displays this random number in a two-dimensional code. The user invokes the cooperative application 72B and reads this two-dimensional code. The cooperative application 72B generates an ECDSA key pair and transmits the public key to the authentication server 72 together with the above random number.

The authentication server 72 registers the received public key in a list 72L in association with the user ID corresponding to the random number, followed by transmitting a notification of registration to the cooperative application 72B. The cooperative application 72B displays the notification of registration. Incidentally, the number nID determining the parameter set can be fixed to a particular number, In this case, the number nID need not be saved for each cybername.

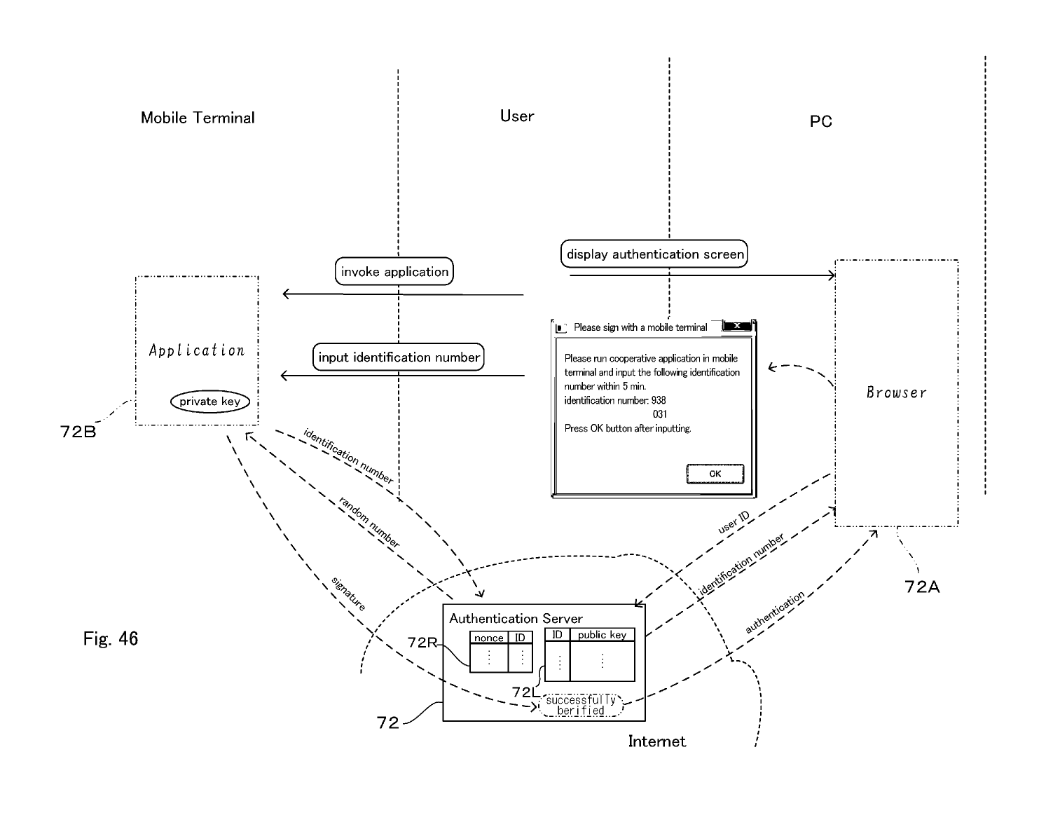

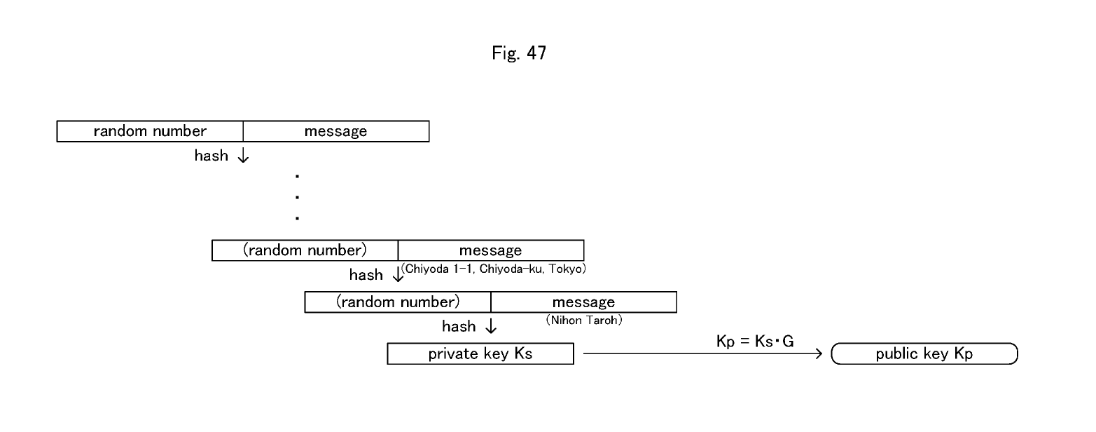

After completing registration, the authentication procedure can be performed with the mobile terminal (FIG. 46). First, the browser 72A accesses the authentication server 72, and displays an authentication screen for performing this authentication method. The authentication server 72 generates a 128 bit random number (nonce). However, if the number (<1048576) corresponding to the higher 20 bits of this random number requires seven digits in the decimal number system, the authentication server 72 repeats generation of a random number until the random number can be represented by six digits. Then, the authentication server 72 transmits the random number corresponding to the higher 20 bits to the browser 72A as the identification number. Furthermore, the authentication server 72 saves this random number in the ring buffer 72R in association with the user ID.

The authentication screen of the PC displays the identification number transmitted from the authentication server 72 in a dialog. This is the same as illustrated in FIG. 44.

The user invokes the cooperative application 72B by the mobile terminal and enters this identification number. The cooperative application 72B then accesses the authentication server 72 and transmit this identification number. The authentication server 72 searches the ring buffer 72R for the random number whose higher 20 bits match this identification number, and returns this random number to the cooperative application 72B.

The cooperative application 72B calculates a signature on the received random number and returns this signature to the authentication server 72. The authentication server 72 verifies this signature, and authenticates the PC as the normal user corresponding to the user ID if the verification is successful.

Meanwhile, it is also possible to display the entirety of the random number rather than the identification number by the browser 72A in the form of a two-dimensional code, such that the cooperative application 72B of the mobile terminal reads the random number and transmits the signature thereof to the authentication server 72. If the signature is successfully verified, the authentication server 72 authenticates the PC as the normal user corresponding to the user ID.

### Example 9

When a key pair of ECDSA is generated, a private key is first generated as a random number having the key length (accurately, a random number smaller than the order n as a parameter). The public key is calculated from the private key.

In the embodiment 9, the private key is generated as a hash value rather than a random number. The security of a hash value may be lower than that of a random number. Accordingly, it is recommended to select a longer key length. In this example, the key length is 256 bits long. The other configurations of this example are the same as those of any one of the above embodiments 3 through 8. If desired, however, this embodiment can be applied to any electronic signature system in which a private key can be freely selected. The preimage of the hash value is an arbitrary message to which a random number is added. One of applications will be described below.

It is a feature of the present invention that signatures can be used on an anonymous base. However, it may be the case where the first person using a cybername has to confirm identity. In order to deal with this situation, a private key can be generated in advance by preparing a message in which the owner of the private key can be identified, adding a random number to this message, and calculating the hash value thereof to be used as the private key.

For example, the message is such that “Nihon Taroh, Chiyoda 1-1, Chiyoda-ku, Tokyo”, A33MGzOwOUzjJwpz8l+jvRT9ZL48DTEVFQ+2mGOL8ptl″. The random number is encoded by Base64. The hash value of this text can be calculated by SHA256 to generate a private key. If the hash value is greater than the order n, the hash calculation is repeated until a private key smaller than the order n is obtained. The text as the preimage is saved in order not to be leaked. Preferably, the preimage is saved by printing on a sheet rather than storing in the PC as data. The preimage is usually not used and therefore can be saved in this manner.

For example, in the advanced settings screen shown in FIG. 30, a user may enter “Nihon Taroh, Chiyoda 1-1, Chiyoda-ku, Tokyo” to a box for embedded messages, followed by pressing a generation button. The signature verification program then generates a 256 bits random number and updates the text in the box to “Nihon Taroh, Chiyoda 1-1, Chiyoda-ku, Tokyo”, A33MGzOwOUzjJwpz8l+jvRT9ZL48DTEVFQ+2mGOL8ptl”. Then, the signature verification program calculates the hash value of this text to obtain a private key, and calculates the public key corresponding thereto by the use of a generator which is one of the parameters. The private key and the public key are displayed in boxes respectively.

After the user enters a cybername and a password and presses a “store” button, the signature verification program stores the cybername, nID, the public key and the private key which is encrypted with the password. When a “printing” button is pressed, the signature verification program prints the cybername, nID, the public key, the private key as plain text, the embedded message to which a random number is added.

Unless disclosing the text of the preimage, the usage of a signature is the same as that of the above example which simply makes use of a random number. The preimage may be effectively disclosed, for example, in the following scenario.

Nihon Taroh was transmitting information with the cybername “$Suzuki_qv2” in a number of sites in the Internet. His activity in the Internet was always associated with the cybername, but virtually on an anonymous base. One day, he created an original movie and posted it with a signature in a video-sharing website. This movie work made waves and the cybername “$Suzuki_qv2” stepped up its presence. Unfortunately, however, the private key was leaked concurrently.

On the other hand, a company noticed the original movie and offered to purchase it. Nevertheless, since the private key had been leaked, many persons named “$Suzuki_qv2” visited the company. Every person could sign correctly. However, Nihon Taroh could prove that he is the first person owning the private key by showing the preimage of the private key.

In this case, the private key is used for the purpose of claiming the copyright to the valuable information with a signature to which individually identifiable information is connected. Conversely, the following negative case may be considered. For example, harmful information is posted on the Internet with a signature to which individually identifiable information of another person is connected. Thereafter, the preimage of the private key is disclosed. The aim is to defame this another person. However, since anyone can be done such an act, there is apparently little believability.

Anyway, as long as correctly used, the preimage can be an evidence that the first person claims own identity. On the other hand, in exchange for identity claiming, it may compromise the ability of generating signatures thereafter. Preferably, in advance of disclosing the private key, a new key pair is generated, and the new public key is signed with the previous private key, followed by declaring replacement. In the case of a law suit or the like, an in-camera prosecution may be selected.

This technique can be nested as illustrated in FIG. 41. For example, a private key is generated by calculating a hash value h1 of “Nihon Taroh living in Chiyoda 1-1, Chiyoda-ku, Tokyo started using the public key on Jul. 1, 2012” to which a random number is added, and further calculating the private key as a hash value of “Nihon Taroh started using the public key on Jul. 1, 2012” to which the hash value h1 is added. As has been discussed above, it is proved that the first person is “Nihon Taroh” by showing the private key and “Nihon Taroh . . . using the public key on Jul. 1, 2012” with the hash value h1. In addition to this, only the first person (knowing the first random number and the message) can disclose the residence “Chiyoda 1-1, Chiyoda-ku, Tokyo” if desired. In this case, the first random number and the messages are stored in a printed sheet. Incidentally, if the number of bits of the hash value is larger than the number of bits of the private key, a random number is used as a padding.

### INDUSTRIAL APPLICABILITY

As has been discussed above, the identifier management system in accordance with the present invention is effective to improve the quantity and quality of information transmitted by individuals on the Internet.

### EXPLANATION OF SYMBOLS

10 management server
23 message to be signed
55 authentication data (URL)
61 cybername management table
62 message management table
63 representative value of link information
70 mediating server
71A signature verification program
71B cooperative application
72 authentication server
72A browser
72B cooperative application

1-5. (canceled)

6. A computer-implemented signing/verifying method, comprising:
the steps of, for signing a message,
receiving a message character string as a message body to be signed;
generating an electronic signature on the character string;
generating a character string which corresponds to the electronic signature; and
generating a signed character string by joining the message character string with the character string corresponding to the electronic signature, and
the steps of, for verifying the signed character string,
receiving the signed character string;
verifying the signed character string;
displaying the result of verification; and
displaying other signed character strings each of which has been signed with the same private key as the above signed character string,
wherein each signed character string is displayed on a computer screen as a string which can be viewed by users.

7. The computer-implemented signing/verifying method of claim 1 wherein the character string corresponding to the electronic signature is a character string which is obtained by converting the electronic signature by Base64.

8. The computer-implemented signing/verifying method of claim 1 wherein the other signed character strings are displayed in response to a user request after displaying the result of verification.

9. The computer-implemented signing/verifying method of claim 1 wherein the other signed character strings are displayed after verifying the signatures thereof.
